(19) United States
(12) Patent Application Publication
(10) Pub. No.: US 2017/0187483 A1
(43) Pub. Date: Jun. 29, 2017

(54) LOW TRANSIT LOSS ADD-DROP MULTIPLEXING NODE FOR ALL OPTICAL NETWORKING

(71) Applicants: MOHAMMAD MEHDI MANSOURI RAD, KANATA (CA); HAMID MEHRVAR, OTTAWA (CA)

(72) Inventors: MOHAMMAD MEHDI MANSOURI RAD, KANATA (CA); HAMID MEHRVAR, OTTAWA (CA)

(73) Assignee: HUAWEI TECHNOLOGIES CO., LTD., Shenzhen (CN)

(21) Appl. No.: 14/982,359

(22) Filed: Dec. 29, 2015

(51) Int. Cl. H04J 14/02; H04Q 11/00

(52) U.S. Cl. CPC H04J 14/0204; H04Q 11/0067; H04Q 2011/0009; H04Q 2011/0016; H04Q 2011/0018

(57) ABSTRACT

Methods and apparatus for add-drop multiplexing in all optical networking are provided. A tunable optical filter is controlled to drop a first portion of an incoming optical signal in a first wavelength band and pass a second portion of the incoming optical signal in a second wavelength band. The dropped first portion is distributed among local drop optical output ports with a demultiplexer. A multiplexer combines local add optical input signals in a third wavelength band into an add optical input signal and the tunable optical filter is controlled to add the add optical input signal to the passed second portion of the incoming optical signal. The tunable optical filter is configured to lower an optical loss for the passed second portion of the incoming optical signal at the account of a corresponding increase of an optical loss in the dropped first portion and/or the add optical input signal.

### FIELD OF THE APPLICATION

The application relates to all optical networking (AON) generally and more particularly to add-drop multiplexing (ADM) nodes in AON applications.

### BACKGROUND

In order to allow one or more optical channel wavelengths to be added to and/or dropped from an optical signal that is otherwise passing through an optical node within an all optical network, some form of optical add-drop multiplexing functionality may be implemented in such nodes.

An optical signal may pass through a number of optical nodes as it traverses an all optical network. From a link budgeting perspective, it is therefore generally advantageous to minimize optical losses that an optical signal may incur as it passes through an optical node, including losses that may be incurred through the add-drop multiplexing functionality.

### SUMMARY

An embodiment provides an apparatus for all optical networking (AON) that includes a tunable optical filter and a demultiplexer. The tunable optical filter has an incoming optical input port to receive an incoming optical signal, a drop optical output port and an outgoing optical output port. The tunable optical filter is controllable to drop a first portion of the incoming optical signal in a first wavelength band to the drop optical output port and pass a second portion of the incoming optical signal in a second wavelength band to the outgoing optical output port. The demultiplexer is optically connected to the drop optical output port of the tunable optical filter and is configured to distribute the dropped first portion of the incoming optical signal in the first wavelength band among local drop optical output ports.

The tunable optical filter may be configured to lower an optical loss between the incoming optical input port and the outgoing optical output port in the second wavelength band at the account of a corresponding increase of an optical loss between the incoming optical input port and the drop optical output port in the first wavelength band.

The tunable optical filter may be wavelength-tunable, bandwidth-tunable, or both. For example, the tunable optical filter may be wavelength-tunable to adjust a center wavelength of the first wavelength band and/or bandwidth-tunable to adjust bandwidth of the first wavelength band.

In some cases, the tunable optical filter may be implemented with a tunable Mach-Zehnder Interferometer and Resonator Ring (MZI/RR) hybrid optical filter.

In some such cases, the tunable MZI/RR hybrid optical filter may include a tunable RR filter that includes a resonator ring and a variable optical coupler. The variable optical coupler may be controllable to adjust the bandwidth of the tunable RR filter.

The tunable optical filter may also include an add optical input port. In which case, the tunable optical filter may be configured to add an add optical input signal in a third wavelength band from its add optical input port to its outgoing optical output port. The apparatus may further include a multiplexer configured to combine local add optical input signals in the third wavelength band from local add optical input ports into the add optical input signal.

In some implementations, the tunable optical filter may be implemented with two three-port tunable optical filters. A first to the two three-port tunable optical filter may be controllable to drop the first portion of the incoming optical signal in the first wavelength band to the drop optical output port and pass the second portion of the incoming optical signal in the second wavelength band to a pass optical output port. The second of the two three-port tunable optical filters may be controllable to add an add optical input signal in the third wavelength band from the add optical input port to the outgoing optical output port and pass the second portion of the incoming optical signal in the second wavelength band from the pass optical output port of the first three-port tunable optical filter to the outgoing optical output port.

In some such cases, the first three-port tunable optical filter is configured to lower an optical loss in the passed second portion of the incoming optical signal in the second wavelength band at the account of a corresponding increase of an optical loss in the dropped first portion of the incoming optical signal in the first wavelength band. Similarly, the second three-port tunable optical filter may be configured to lower an optical loss in the passed second portion of the incoming optical signal in the second wavelength band at the account of a corresponding increase of an optical loss in the add optical input signal in the third wavelength band.

The demultiplexer may include multiple 1×2 optical splitters arranged to distribute the dropped first portion of the incoming optical signal in the first wavelength band among the local drop optical output ports.

In other embodiments, the demultiplexer may include multiple 1×2 optical switches configured as variable splitters controllable to selectively distribute the dropped first portion of the incoming optical signal in the first wavelength band among the local drop optical output ports.

In some embodiments, the tunable optical filter is a main tunable optical filter, and the demultiplexer is implemented with multiple additional tunable optical filters arranged in a cascade, with a first tunable optical filter in the cascade optically connected to the drop optical output port of the main tunable optical filter to receive the dropped first portion of the incoming optical signal in the first wavelength band. In such implementations, each tunable optical filter in the cascade may be tunable to drop a respective portion of the dropped first portion of the incoming optical signal to a respective local drop optical output port of the local drop optical output ports. The tunable optical filters in the cascade may each be wavelength-tunable to drop a respective channel wavelength in the first wavelength band.

Similarly, the multiplexer may be implemented with multiple tunable optical filters arranged in a cascade, with a last tunable optical filter in the cascade optically connected to the add optical input port of the main tunable optical filter to transmit the add optical input signal in the third wavelength band. In such implementations, each tunable optical filter in the cascade may be tunable to add a respective local add optical input signal from a respective local add optical input port into the add optical input signal for the main tunable optical filter. The tunable optical filters in the cascade may each be wavelength-tunable to add a respective channel wavelength in the third wavelength band.

Another embodiment provides a method related to drop functionality for optical add-drop multiplexing in all optical networking. The method includes controlling a tunable optical filter to drop a first portion of an incoming optical signal in a first wavelength band and pass a second portion of the incoming optical signal in a second wavelength band. The method further includes distributing the dropped first portion of the incoming optical signal in the first wavelength band among local drop optical output ports.

In some embodiments, controlling the tunable optical filter involves configuring the tunable optical filter to lower an optical loss in the passed second portion of the incoming optical signal in the second wavelength band at the account of a corresponding increase of an optical loss in the dropped first portion of the incoming optical signal in the first wavelength band.

In some cases, controlling the tunable optical filter involves wavelength-tuning the tunable optical filter to adjust a center wavelength of the first wavelength band, bandwidth-tuning the tunable optical filter to adjust bandwidth of the first wavelength band, or both.

In order to provide add functionality, the method may further include combining local add optical input signals in a third wavelength band into an add optical input signal and controlling the tunable optical filter to add the add optical input signal to the passed second portion of the incoming optical signal in the second wavelength band.

In some implementations, the tunable optical filter may be implemented with two three-port tunable optical filters. In such implementations, the method may include controlling a first three-port tunable optical filter to drop the first portion of the incoming optical signal in the first wavelength band and pass the second portion of the incoming optical signal in the second wavelength band, and controlling a second three-port tunable optical filter to add the add optical input signal in the third wavelength band to the passed second portion of the incoming optical signal in the second wavelength band. In some such cases, controlling the first three-port tunable optical filter involves configuring the first three-port tunable optical filter to lower an optical loss in the passed second portion of the incoming optical signal in the second wavelength band at the account of a corresponding increase of an optical loss in the dropped first portion of the incoming optical signal in the first wavelength band. Similarly, controlling the second three-port tunable optical filter may involve configuring the second three-port tunable optical filter to lower an optical loss in the passed second portion of the incoming optical signal in the second wavelength band at the account of a corresponding increase of an optical loss in the add optical input signal in the third wavelength band.

In some implementations, distributing the dropped first portion of the incoming optical signal in the first wavelength band among local drop optical output ports involves controlling multiple tunable optical filters arranged in a cascade. For example, each tunable optical filter in the cascade may be operable to drop a respective portion of the dropped first portion of the incoming optical signal to a respective local drop optical output port. In some such embodiments, controlling the multiple tunable optical filters arranged in the cascade involves wavelength-tuning one or more of the tunable optical filters to each drop a respective channel wavelength in the first wavelength band.

Similarly, in those embodiments in which the method further includes combining local add optical input signals in the third wavelength band into the add optical input signal, such combining may involve controlling multiple tunable optical filters arranged in a cascade. For example, each tunable optical filter in the cascade may be tunable to add a respective local add optical input signal from a respective local add optical input port into the add optical input signal. In some such embodiments, controlling the multiple tunable optical filters arranged in the cascade involves wavelength-tuning one or more of the tunable optical filters to each add a respective channel wavelength in the third wavelength band.

### BRIEF DESCRIPTION OF THE DRAWINGS

Embodiments will now be described with reference to the attached drawings in which:

FIG. 1A is a block diagram of an example of an optical resonator ring structure configured as an all-pass or notch filter;

FIG. 1B is a block diagram of an example of an optical resonator ring structure configured as an optical ADM;

FIG. 2 is a plot of the spectral responses of the optical resonator ring structures of FIGS. 1A and 1B;

FIG. 3 is a plot of 3 dB bandwidth vs. coupling efficiency of an optical coupler in a resonator ring structure;

FIG. 4 is a block diagram of an example of an apparatus according to an embodiment of the present invention;

FIG. 5 is a block diagram of another example of an apparatus according to an embodiment of the present invention;

FIG. 6 is a block diagram of an example of a tunable optical filter structure according to an embodiment of the present invention;

FIG. 7 is a block diagram of another example of a tunable optical filter structure that includes a first tunable optical filter for optical drop functionality and a second tunable optical filter for optical add functionality according to an embodiment of the present invention;

FIG. 8 is block diagram of an example of a tunable optical filter that may be used in an embodiment of the present invention to implement the first tunable optical filter of the tunable optical filter structure of FIG. 7;

FIG. 9 is block diagram of an example of a tunable optical filter that may be used in an embodiment of the present invention to implement the second tunable optical filter of the tunable optical filter structure of FIG. 7;

FIG. 10 is a plot of an example transfer function of the tunable optical filter structure of FIG. 7;

FIG. 11 is a block diagram of an example demultiplexing structure with cascaded 1×2 optical switches for local optical drop ports and an example multiplexing structure with cascaded 2×1 optical switches for local optical add ports according to an embodiment of the present invention;

FIG. 12 is a block diagram of an example multiplexing structure with cascaded tunable optical filters for local optical drop ports and an example demultiplexing structure with cascaded tunable optical filters for local optical add ports according to an embodiment of the present invention;

FIG. 13 is a block diagram of an example of a multiplexing and demultiplexing structure with cascaded tunable optical filter structures according to an embodiment of the present invention;

FIG. 14 is a block diagram of an example of a tunable optical filter structure that may be used in the multiplexing and demultiplexing structure of FIG. 13;

FIG. 15 is a block diagram of an example of a uni-directional optical ring network with multiple optical nodes having optical add-drop functionality according to an embodiment of the present invention;

FIG. 16 is a block diagram of an example of an apparatus according to an embodiment of the present invention;

FIG. 17 is a block diagram of an example of a bi-directional optical ring network with multiple optical nodes having optical add-drop functionality according to an embodiment of the present invention;

FIG. 18 is a block diagram of an example of another optical network with multiple optical nodes having optical add-drop functionality according to an embodiment of the present invention;

FIG. 19 is a flow diagram of an example method according to an embodiment of the present invention.

### DETAILED DESCRIPTION OF EMBODIMENTS

As noted above, optical add and/or drop multiplexing functionality may be included in an optical node of an all optical network in order to allow one or more optical channel wavelengths to be added to and/or dropped from an optical signal that is otherwise passing through the optical node.

One conventional way to implement optical add-drop multiplexing functionality utilizes a wavelength-selective switch structure that includes an optical switch fabric arranged between first and second arrayed waveguides (AWGs). The optical switch fabric allows optical channel wavelength components separated from an incoming optical signal by the first AWG to be either switched to local optical drop ports to be “dropped” from the incoming optical signal or switched to the second AWG to be recombined into an outgoing optical signal, which results in the optical channel wavelength components being “passed” from the incoming optical signal to the outgoing optical signal. The optical switch fabric may also allow optical channel wavelength components from local optical add ports to be switched to the second AWG to be combined in the outgoing optical signal, and thus, “added” to the outgoing optical signal.

However, such implementations have some potential drawbacks, including losses incurred through the AWGs and the optical switch fabric, which can be particularly problematic in implementations where an optical signal may traverse through several nodes on its way from its source to its destination. Such losses may be accounted for by launching the optical signal with a higher initial transmission power and/or utilizing optical repeaters with optical amplifiers at intermediate locations within an optical network in order to boost optical transmission power. However, the use of higher power optical transmitters and/or installing optical repeaters often comes at the expense of increased costs and equipment complexity.

In addition, the AWGs used in such structures often have fixed channel spacings that are designed to be aligned with the channel spacings of a telecommunications standard, such as the International Telecommunications Union (ITU) grid channel spacings for Dense Wavelength Division Multiplexing (DWDM) in the C-Band with 50, 100 or 200 GHz channel spacings. However, should the channel spacings in a given standard be changed and/or should different channel spacings otherwise be wished to be used, then AWGs with fixed channel spacings aligned with the previously used channel spacings may not be usable with new/altered channel spacings.

In many applications, the number of degrees or directions that an optical node transmits and receives optical signals is limited to two and only a very small percentage of channel wavelengths are added/dropped at any given node.

In one aspect of the present invention, optical add-drop multiplexing functionality is implemented for all optical networking using tunable optical filters to add and/or drop channel wavelengths/bands. In particular, embodiments of the present invention provide an apparatus for all optical networking in which tunable optical filters are used to drop and/or add channel wavelengths/bands in drop and/or add bands, and to pass channel wavelengths/bands in a pass band. For the dropped and/or added channel wavelengths/bands in the drop and/or add bands, a multiplexer may be used to combine local add channel wavelengths/bands from local add ports, and a demultiplexer may be used to distribute local drop channel wavelengths/bands among local drop ports. According to such embodiments, the center wavelength and/or the bandwidth of the pass, add and/or drop bands may be tunable/controllable. As discussed in further detail below, such structures can potentially provide cost effective and customizable apparatuses for Add-Drop Multiplexing, particularly for Metro applications.

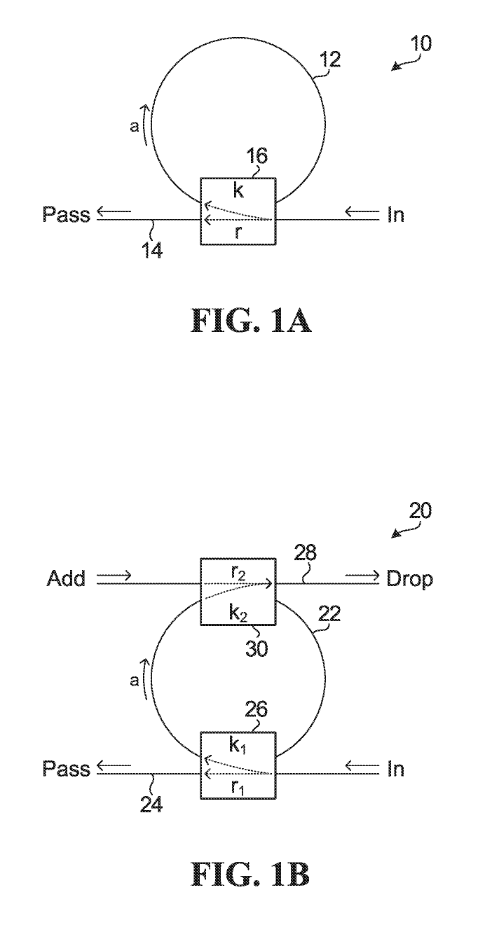

A brief description of a few example optical filter structures will now be provided with reference to FIGS. 1 to 3.

FIG. 1A is a block diagram of an example of an optical resonator ring structure 10 configured as an all-pass or notch filter. The optical resonator ring structure 10 includes an optical waveguide 14 optically coupled to an optical resonator ring 12 through an optical coupler 16. The optical waveguide 14 has an optical input “In” and an optical output “Pass”.

In operation, the optical coupler 16 couples a portion of an optical input signal received at In into the optical resonator ring 12. When optical waves in the optical resonator ring 12 build up a round trip phase shift that equals an integer multiple of 2π, the waves interfere constructively and the ring is in resonance.

Filtering properties of the optical resonator ring structure 10 are mainly determined by ring properties such as length, loss, and coupling efficiencies in the optical coupler 16.

For illustrative purposes, if continuous wave operation is assumed, and also assuming that reflections back into the waveguide 14 are negligible, which may not be practical in many implementations, it can be shown that the transfer function, Tₙ, expressed in terms of intensity transmission is equal to:

$${T}_{n} = \frac{{I}_{pass}}{{I}_{input}} = \frac{{a}^{2} - 2 ra cos φ + {r}^{2}}{1 - 2 ar cos φ + {( ra )}^{2}} \qquad ( 1 )$$

where a is the round trip loss coefficient, including both propagation loss in the ring 12 and loss in the coupler 16, r is a self-coupling coefficient of the coupler 16, φ is the single-pass round trip phase shift of the ring 12 and is equal to φ=βL, where L is the round trip length of the ring 12 and β is the propagation constant of the circulating mode.

As noted above, r is the self-coupling coefficient of the coupler 16. As shown in FIG. 1A, the coupler 16 also has a cross-coupling coefficient k. The power spitting ratios for the coupler 16 are r² and k². If there are no losses in the coupler 16, then the power splitting ratios of the coupler can be assumed to satisfy the relationship r²+k²=1.

The ring 12 is resonant when the phase φ is a multiple of 2π, or when the wavelength of the light fits an integer number of times inside the optical length of the ring 12.

For an ideal ring with zero or near-zero attenuation, i.e., a≈1, the transmission is unity for all values of detuning φ. Under critical coupling, when the coupled power is equal to the power loss in the ring, 1−a²=k² or r=a, the transmission at resonance drops to zero. The phase argument of the field transmission varies periodically with frequency. The all-pass resonator based filter structure 10 delays an incoming optical signal via the temporary storage of optical energy within the resonator ring 12.

While the optical coupler 16 is shown as a discrete element in FIG. 1A, in many cases the optical coupling provided by optical coupler 16 may be implemented by simply arranging optical resonator ring loop 12 in close proximity of optical waveguide 14.

The optical resonator ring structure 10 shown in FIG. 1A is configured as a two-port all-pass or notch filter. A similar optical resonator ring structure can be configured to provide four port optical filtering, and thus provide optical add-drop multiplexing functionality.

FIG. 1B is a block diagram of an example of an optical resonator ring structure 20 configured as an optical add-drop multiplexor (ADM).

The optical resonator ring structure 20 includes a first optical waveguide 24 optically coupled to an optical resonator ring 22 through a first optical coupler 26, and a second optical waveguide 28 optically coupled to the optical resonator ring 22 through a second optical coupler 30. The first optical waveguide 24 has an optical input “In” and an optical output “Pass”. The second optical waveguide 28 has an optical input “Add” and an optical output “Drop”.

In operation, the first optical coupler 26 couples a portion of an optical input signal received at In into the optical resonator ring 22. The second optical coupler 30 couples a portion of the optical input signal circulating in the optical resonator ring 22 from the ring to the second optical waveguide 28 where it propagates to the optical Drop output. Similarly, the second optical coupler 30 couples a portion of an optical add signal received at Add into the optical resonator ring 22, and the first optical coupler 26 couples a portion of the optical add signal circulating in the optical resonator ring 22 from the ring to the first optical waveguide 24 where it propagates to the optical Pass output. Effectively, the optical coupler 30 plays the role of a filter, allowing a portion of the light received from Add to be forwarded to the Pass port. Similarly, the optical coupler 26 has mainly functions as a filter, allowing portions of the light received from the In port to be forwarded to the Drop and Pass ports. In practice, it may be desirable to not have a substantial amount of light going from Add to Drop, which means that there can be some design considerations and trade-offs when designing the coupling coefficients of the optical couplers 26 and 30, for example.

As with the optical resonator ring structure 10 shown in FIG. 1A, the filtering properties of the optical resonator ring structure 20 shown in FIG. 1B are mainly determined by ring properties such as length, loss, and coupling efficiencies in the optical couplers 26 and 30.

For illustrative purposes, if continuous wave operation is again assumed, and also assuming that reflections back into the waveguide 24 are negligible, which may not be practical in many implementations, it can be shown that the transfer function, Tₚ, from the optical input In to the optical output Pass, and the transfer function, T_{d}, from the optical input In to the optical output Drop, expressed in terms of intensity transmission are equal to:

$$\begin{matrix}{T}_{p} = \frac{{I}_{pass}}{{I}_{input}} = \frac{{r}_{2}^{2} {a}^{2} - 2 {r}_{1} {r}_{2} a cos φ + {r}_{1}^{2}}{1 - 2 {r}_{1} {r}_{2} a cos φ + {( {r}_{1} {r}_{2} a )}^{2}} & ( 2 ) \\ {T}_{d} = \frac{{I}_{drop}}{{I}_{input}} = \frac{( 1 - {r}_{1}^{2} ) ( 1 - {r}_{2}^{2} ) a}{1 - 2 {r}_{1} {r}_{2} a cos φ + {( {r}_{1} {r}_{2} a )}^{2}} & ( 3 )\end{matrix}$$

where a is the round trip loss coefficient, including both propagation loss in the ring 22 and losses in the couplers 26 and 30, r₁ is a self-coupling coefficient of the first coupler 26, r₂ is a self-coupling coefficient of the second coupler 30, φ is the single-pass round trip phase shift of the ring 22 and is equal to φ=βL, where L is the round trip length of the ring 22 and β is the propagation constant of the circulating mode.

The first and second optical couplers 26 and 30 also each have a cross-coupling coefficient, k₁ and k₂, respectively. The power spitting ratios for the first coupler 26 are r₁² and k₁². If there are no losses in the first coupler 26, then the power splitting ratios of the first coupler can be assumed to satisfy the relationship r₁²+k₁²=1. Similarly, The power spitting ratios for the second coupler 30 are r₂² and k₂². If there are no losses in the second coupler 30, then the power splitting ratios of the second coupler can be assumed to satisfy the relationship r₂²+k₂²=1.

The ring 22 is resonant when the phase φ is a multiple of 2π, or when the wavelength of the light fits an integer number of times inside the optical length of the ring 22.

If the attenuation is negligible, i.e., a≈1, critical coupling occurs when the cross-coupling coefficients of the first and second optical couplers are symmetric, i.e., k₁=k₂. For a lossy resonator ring structure, it can be shown that critical coupling occurs when the losses match the coupling according to r₂a=r₁.

While the foregoing has discussed the transfer functions between the optical input In and the optical outputs Pass and Drop of the optical ring resonator structure 20, a similar discussion of the transfer functions between the optical input Add and the optical outputs Pass and Drop is omitted for the sake of conciseness.

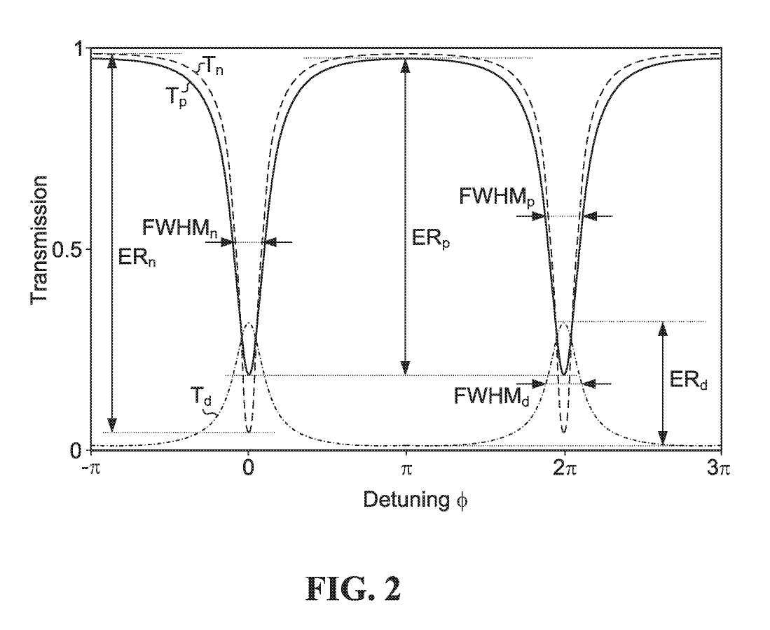

FIG. 2 is a plot of the spectral responses of the optical resonator ring structures 10 and 20 of FIGS. 1A and 1B, respectively, according to equations (1) to (3). Spectral features, including Full Width at Half Maximum (FWHM) and Extinction Ratio (ER), are indicated at FWHMₙ and ERₙ, respectively, for the optical resonator ring structure 10, and are indicated at FWHMₚ and ERₚ, respectively, for the Pass output for the optical resonator ring structure 20 and at FWHM and ER_{d}, respectively, for the Drop output for the optical resonator ring structure 20.

For illustrative purposes, the roundtrip loss coefficient, a, and the self-coupling coefficients, r, r₁, and r₂, have been assumed to be as follows: a=0.85, r=r₁=r₂=0.9. However, it is to be appreciated that these values were chosen for illustrative purposes only and other values may be used. It is noted that because of the additional losses introduced by the second coupler 30, the transmission spectrum, Tₚ, for the Pass output of the add-drop optical resonator ring structure 20 has a broader notch than that of the transmission spectrum, Tₙ, of the all-pass or notch filter optical resonator ring structure 10. Also, the coupling for the add-drop optical resonator ring structure 20 is further from critical coupling, resulting in a smaller extinction ratio, i.e., ERₚ<ERₙ. It is also noted that the peaks for the transmission spectrum of the Drop output, T_{d}, of the add-drop optical resonator ring structure 20 at 0 and 2π of detuning are less than the transmission peaks for the transmission spectrum of the Pass output, Tₚ, indicating that drop channels experience greater attenuation than pass or transit channels.

Some additional spectral features that are not explicitly indicated in FIG. 2, include Free-Spectral Range (FSR) and 3 dB bandwidth.

The FSR for an optical resonator ring structure can be calculated by the length of the ring (including all coupler(s), ring(s), etc.). Equation 4 shows the dependency of the FSR to the physical parameter of the ring

$$F S R = \frac{c}{{n}_{g} L} \qquad ( 4 )$$

where c is the speed of light in vacuum, n_{g} is the effective refractive index of the optical waveguide material used to implement the ring structure, and L is the total length of the ring. Note that for a circular ring with radius of R, we have L=2πR. In accordance with Equation 4, it can be shown that an FSR of greater than 1 THz can potentially be realized for a ring length of 50 micrometers and a refractive index n_{g} of 4.2, which is the refractive index of silicon in one particular example of silicon on insulator (SOI) technology.

A finesse factor for a resonator may be defined as the ratio of FSR and the FWHM resonance width as follows:

$$Finesse = \frac{F S R}{{λ}_{res}} \qquad ( 5 )$$

where λᵣₑₛ is the center wavelength of resonance of the resonator ring structure.

Similarly, a quality factor, Q, for a resonator may be defined as a measure of the sharpness of resonance relative to its central frequency according to:

$$Q = \frac{{λ}_{res}}{F W H M} \qquad ( 6 )$$

The physical meaning of the finesse and quality factors relates to the number of round-trips made by the energy in the resonator ring structure before being lost to internal loss and the optical waveguides.

The 3 dB bandwidth of an optical resonator ring structure can be expressed in terms of the FSR and quality factor Q as follows:

$$Δ {f}_{3 d B} \approx \frac{F S R}{Q} = \frac{1 - r}{π \sqrt{r}} F S R \qquad ( 7 )$$

In equation 7, r represent the coupling efficiency of the resonator ring structure. When the resonator ring structure also imposes some loss in the ring, that loss should be incorporated into r in equation 7.

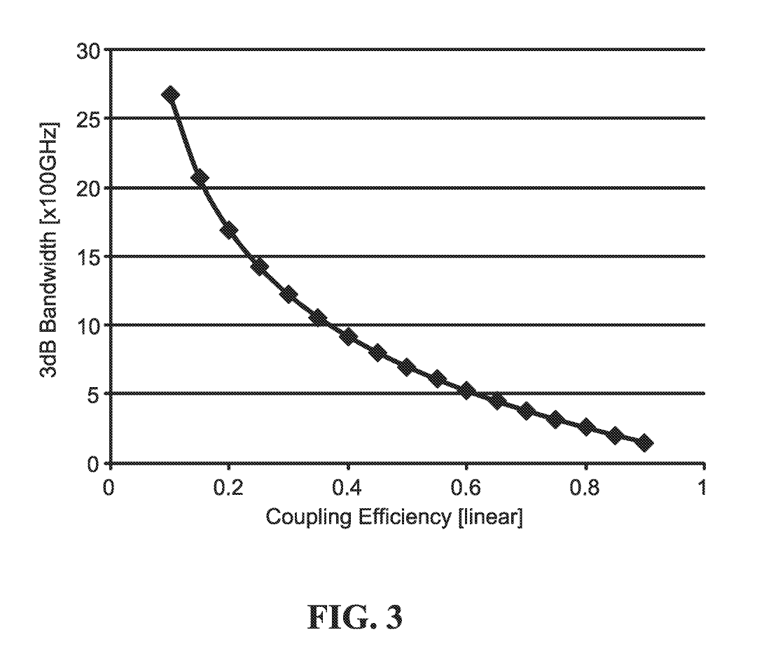

FIG. 3 is a plot of 3 dB bandwidth vs. coupling efficiency of an optical coupler in an optical resonator ring structure, where the 3 dB bandwidth has been calculated using equation 7 and an FSR defined according to equation 4. As noted above and indicated in Equation 5, increased optical coupling losses for an optical resonator ring structure can increase the 3 dB bandwidth of the optical resonator ring structure, e.g., the transmission spectrum, Tₚ, for the Pass output of the add-drop optical resonator ring structure 20 has a broader notch than that of the transmission spectrum, Tₙ, of the all-pass or notch filter optical resonator ring structure 10. This is shown clearly in FIG. 3, which shows a drop off in the 3 dB bandwidth as the coupling efficiency increases. It is noted that for illustrative purposes the results plotted in FIG. 3 are based on an assumed ring length L=25 micrometers, and an assumed refractive index n_{g}=4.2. It is further noted that in the illustrative example shown in FIG. 3, a coupling efficiency of ≈0.9 provides a 3 dB bandwidth of a ≈100 GHz, which increases to ≈500 GHz for a coupling efficiency of a ≈0.6, with a further increase to a ≈700 GHz for a coupling efficiency of a ≈0.5.

While FIG. 1B shows one example of a simple resonator ring structure 20 configured to provide add-drop functionality, other optical filter structures can potentially be used to provide add-drop functionality, although often at the cost of increased complexity.

In other approaches, other structures, such as a Mach-Zehnder Interferometer (MZI) structure, may be employed to potentially improve optical resonator ring based filters.

For example, utilizing an MZI structure in conjunction with a resonator ring structure similar to the all-pass resonator ring structure 10 shown in FIG. 1A can potentially improve the extinction ratio of the resulting filter response.

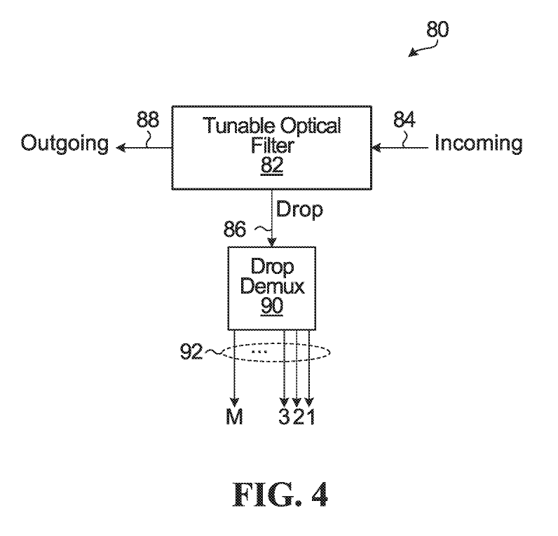

Some general background on optical filtering has been provided above. Illustrative examples of how optical filtering, and particularly tunable optical filtering, may be leveraged to provide practical add and/or drop functionality for all optical networking in accordance with various embodiments of the present invention will now be discussed with reference to FIGS. 4 to 22.

FIG. 4 is a block diagram of an example of an apparatus 80 for all optical networking according to an embodiment of the present invention. The apparatus 80 includes a tunable optical filter 82 having an incoming optical input port 84, a drop optical output port 86 and an outgoing optical output port 88. The apparatus 80 also includes a drop demultiplexer 90, optically connected to the drop optical output port 86 of the tunable optical filter 82. The drop demultiplexer 90 has multiple local drop optical output ports 92.

In operation, the incoming optical input port 84 receives an incoming optical signal and the tunable optical filter 82 is controllable to drop a first portion of the incoming optical signal in a first wavelength band to the drop optical output port 86 and pass a second portion of the incoming optical signal in a second wavelength band to the outgoing optical output port 88. The drop demultiplexer 90 distributes the dropped first portion of the incoming optical signal in the first wavelength band among the local drop optical output ports 92.

Tunable optical filter 82 and drop demultiplexer 90 may be implemented in a silicon photonics fabrication technology in some embodiments.

A skilled person will understand that tunable optical filter 82 may have one or more control and/or monitoring inputs/outputs to allow for its control; however, such input(s)/output(s) are omitted in the drawing to avoid clutter. For the same reason, control and/or monitoring inputs/outputs have also been omitted in the other drawings.

In some embodiments, tunable optical filter 82 is wavelength-tunable, meaning that the center wavelength of the first wavelength band is adjustable. For example, in some embodiments tunable optical filter 82 may be wavelength-tunable such that the center wavelength of the first wavelength band is tunable across substantially the entire C band spectrum in the wavelength range 1530-1565 nm.

In some embodiments, the tunable optical filter 82 is bandwidth-tunable, meaning that the bandwidth of the first wavelength band is adjustable. For example, in some embodiments tunable optical filter 82 may be bandwidth-tunable such that the bandwidth of the first wavelength band is adjustable from 50 GHz to 500 GHz. With a 50 GHz spacing per channel, a 500 GHZ bandwidth for the first wavelength band could potentially allow up to 10 channels to be dropped. However, it is to be understood that this range is merely one very specific example; other embodiments may have different upper and lower bounds of bandwidth tunability.

There are many possibilities for how the drop demultiplexer 90 may be configured to distribute the dropped first portion of the incoming optical signal in the first wavelength band among the local drop optical output ports 92. For example, in some cases, drop demultiplexer 90 may be configured to split the dropped first portion of the incoming optical signal among each of the local drop optical output ports. In some cases this split may be substantially equal amongst the local drop optical output ports, while in other cases it may be unequal, with some local drop optical output ports outputting a greater portion of the power of the dropped first portion of the incoming optical signal in the first wavelength band. In other embodiments the distribution among the local drop optical output ports is wavelength-selective, such that specific channel wavelength(s) within the first wavelength band are distributed to specific local drop optical output port(s).

In some embodiments, the second portion of the incoming optical signal that is passed to the outgoing optical output port 88 includes multiple second wavelength bands. In some such cases, the second wavelength bands are non-contiguous, and the first wavelength band may be located intermediate two of the second wavelength bands.

It is noted that FIG. 4 depicts an apparatus that implements drop functionality using a tunable optical filter to drop a first portion of an incoming optical signal in a first wavelength band and pass a second portion of the incoming optical signal in a second wavelength band, while a drop demultiplexer is used to distribute the dropped first portion amongst local drop optical output ports. In this way, only the tunable optical filter 82 is in the path of the incoming optical signal received at the incoming optical input port 84, meaning that the second portion of the incoming optical signal in the second wavelength band that is passed to the outgoing optical output port 88 may experience losses associated with its processing by the tunable optical filter 82, but does not incur losses associated with the distribution of the dropped first portion of the incoming optical signal among the local drop optical output ports 92 by the drop demultiplexer 90. This “hierarchical” way of implementing drop functionality, i.e., dropping a first portion of the incoming optical signal in a first wavelength band using the tunable optical filter and then distributing the dropped first portion among the local drop optical output ports using the drop demultiplexer, can potentially reduce the losses incurred by pass channel wavelengths in the second wavelength band(s) relative to architectures that utilize AWGs and a switch fabric to implement ADM functionality.

While FIG. 4 depicts an apparatus that implements drop functionality, a similar structure utilizing a tunable optical filter and an add multiplexer may be used to implement corresponding add functionality.

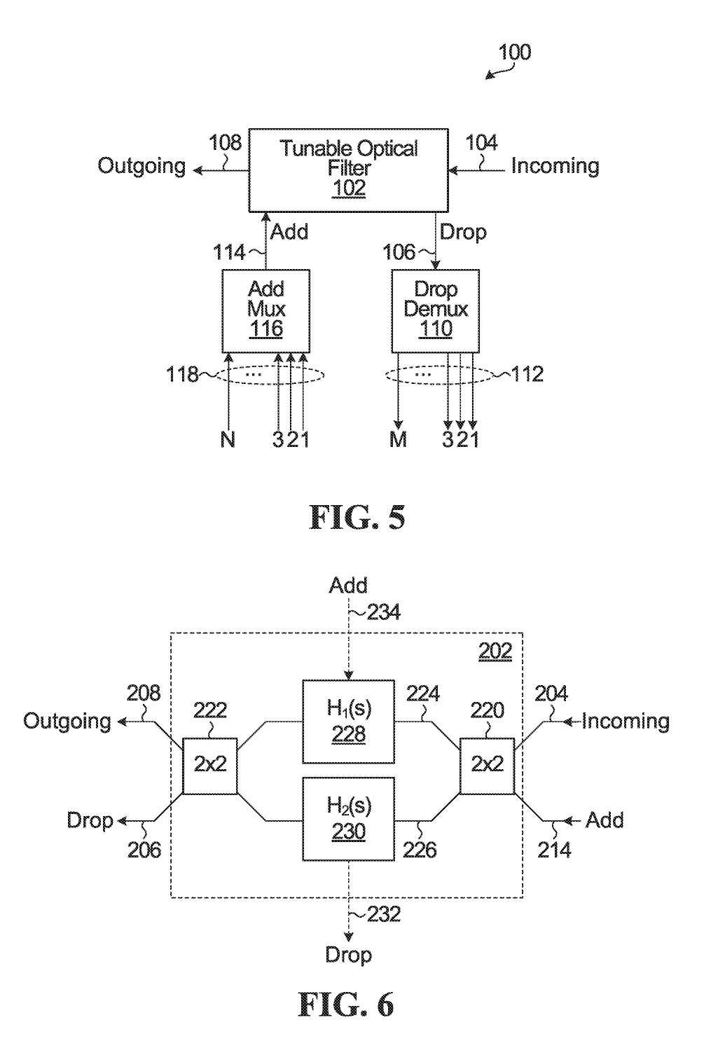

An apparatus that implements both drop and add functionality to implement an optical ADM will now be described with reference to FIG. 5, which is a block diagram of an example of an apparatus 100 according to another embodiment of the present invention. Similar to the apparatus 80 shown in FIG. 4, the apparatus 100 includes a tunable optical filter 102 having an incoming optical input port 104, a drop optical output port 106 and an outgoing optical output port 108, and a drop demultiplexer 110, optically connected to the drop optical output port 106 of the tunable optical filter 102. However, the apparatus 100 further includes an add optical input port 114 and an add multiplexer 116 optically connected to the add optical input port 114. The drop demultiplexer 110 has multiple local drop optical output ports 112 and the add multiplexer 116 has multiple local add optical input ports 118.

In operation, the drop functionality of the apparatus 100 is similar to that of the apparatus 80 shown in FIG. 4. That is, the incoming optical input port 104 receives an incoming optical signal and the tunable optical filter 102 is controllable to drop a first portion of the incoming optical signal in a first wavelength band to the drop optical output port 106 and pass a second portion of the incoming optical signal in a second wavelength band to the outgoing optical output port 108. The drop demultiplexer 110 distributes the dropped first portion of the incoming optical signal in the first wavelength band among the local drop optical output ports 112. To implement add functionality, the add multiplexer 116 is configured to combine local add optical input signals in a third wavelength band from the local add optical input ports 118 into an add optical input signal, and the tunable optical filter 102 is configured to add the add optical input signal from the add optical input port 114 to the outgoing optical signal at the outgoing optical output port 108.

Tunable optical filter 102, drop demultiplexer 110 and add multiplexer 116 may be implemented in a silicon photonics fabrication technology in some embodiments.

In some embodiments, the tunable optical filter 102 is tunable in terms of bandwidth, center wavelength, or both.

In some embodiments, the tunable optical filter 102 is configured so that the third wavelength band and the first wavelength band are non-overlapping. In other embodiments, the tunable optical filter 102 is configured so that the third wavelength band and the first wavelength band at least partially overlap.

Various examples of structures that may be used to implement the tunable optical filter 102, the drop demultiplexer 110 and the add multiplexer 116 will now be discussed with reference to FIGS. 6 to 14.

FIG. 6 is a block diagram of an example implementation of a tunable optical filter 202 according to an embodiment of the present invention. The tunable optical filter 202 is based on an Mach-Zehnder Interferometer (MZI) structure that includes an incoming optical input port 204, a drop optical output port 206, an outgoing optical output port 208, an add optical input port 214, a first 2×2 optical coupler 220, a second 2×2 optical coupler 222, and first and second optical paths 224 and 226, respectively, connected in parallel between the first and second 2×2 optical couplers 220 and 222. The first 2×2 optical coupler 220 has an optical input port optically connected to the incoming optical input port 204, a first optical output port optically connected to the first optical path 224, a second optical input port optically connected to the add optical input port 214, and a second optical output port optically connected to the second optical path 226. The second optical coupler 222 has a first optical input port optically connected to the first optical path 224, a second optical input port optically connected to the second optical path 226, a first optical output port optically connected to the outgoing optical output port 208, and a second optical output port optically connected to the drop optical output port 206. A first tunable filter 228 configured to have a transfer function H₁(s) is optically coupled to the first optical path 224 and a second tunable filter 230 configured to have a transfer function H₂(s) is optically coupled to the second optical path 226.

In operation, an incoming optical input signal is received at the incoming optical input port 204. The incoming optical input signal may include one or more channel wavelengths in a first wavelength band and one or more channel wavelengths in a second wavelength band. The first 2×2 optical coupler 220 couples an incoming optical input signal from the incoming optical input port 204 onto the first optical path 224 and the second optical path 226. The first 2×2 optical coupler 220 also couples an add optical input signal from the add optical input port 214 onto the first optical path 224 and the second optical path 226. The second 2×2 optical coupler 222 couples an optical signal that has propagated over the first optical path to the outgoing optical output port 208 and to the drop optical output port 206. The second 2×2 optical coupler 222 also couples an optical signal that has propagated over the second optical path to the outgoing optical output port 208 and to the drop optical output port 206. The tunable optical filters 228 and 230 optically coupled to the first and second optical paths 224 and 226, respectively, are tunable to filter the optical signals propagating through the first and second optical paths 224 and 226 to cause a first portion of the incoming optical signal in a first wavelength band to be dropped to the drop optical output port 206, to cause a second portion of the incoming optical signal in a second wavelength band to be passed to the outgoing optical output port 208, and to cause a portion of an add optical input signal in a third wavelength band from the add optical input port 214 to be added to the outgoing optical output port 208.

It can be shown that the transfer function for the MZI based tunable filter structure 202 can be expressed as follows:

$$( \begin{matrix}{E}_{Outgoing} \\ {E}_{Drop}\end{matrix} ) = ( \begin{matrix}{T}_{11} & {T}_{12} \\ {T}_{21} & {T}_{22}\end{matrix} ) ( \begin{matrix}{E}_{Incoming} \\ {E}_{Add}\end{matrix} ) \qquad ( 8 )$$

where E_{Outgoing}, E_{Drop}, E_{Incoming} and E_{Add} are intensities of the outgoing optical signal at the outgoing optical output port 208, the drop optical output signal at the drop optical output port 206, the incoming optical input signal at the incoming optical input port 204 and the add optical input signal at the add optical input port 214, respectively, and T₁₁, T₁₂, T₂₁ and T₂₂ are the elements of a transfer matrix T.

The elements of the transfer matrix T can be expressed in terms of the transfer functions H₁(s) and H₂(s) of the first and second tunable optical filters 228 and 230, and the coupling efficiencies of the first and second 2×2 optical couplers 220 and 222. If both of the 2×2 optical couplers 220 and 222 have the same coupling efficiency, k, the elements T₁₁, T₁₂, T₂₁ and T₂₂ of the transfer matrix T can be formulated as follows:

T₁₁=(kH₁+(1−k)H₂)

T₁₂=j\sqrt{k(1−k)}(H₁+H₂)

T₂₁=j\sqrt{k(1−k)}(H₁+H₂)

T₂₂=−(1−k)H₁+kH₂

It is noted that the assumption that both of the 2×2 optical couplers 220 and 22 have the same coupling efficiency, k, has been made above in the interest of simplifying the expressions for the elements T₁₁, T₁₂, T₂₁ and T₂₂. However, more generally the two couplers can have different coupling efficiencies which leads to a more complicated expression for the transfer functions.

From equation 8, it can be seen that the intensity of the outgoing optical output signal at the outgoing optical output port 208 can be expressed as follows:

E_{Outgoing}=T₁₂E_{Add}+T₁₁E_{Incoming} (9)

By approximation and assuming that the filtering implemented by the MZI based tunable optical filter structure 202 acts transparently to transit channel wavelengths (channel wavelengths in the second wavelength band that are passed from the Incoming optical input port 204 to the Outgoing optical output port 208) and add channel wavelengths (channel wavelengths in the third wavelength band that are added from the Add optical input port 214 to the Outgoing optical output port 208), then it can be shown that the loss distribution follows T₁₁²+T₁₂²≈1, which means that there is a trade-off between the incoming transit channels and the added channels. For the purposes of link budget optimization it may be desirable to exploit this trade-off so that losses experienced by transit channels are reduced or minimized in trade for increased losses incurred by locally added/dropped channels.

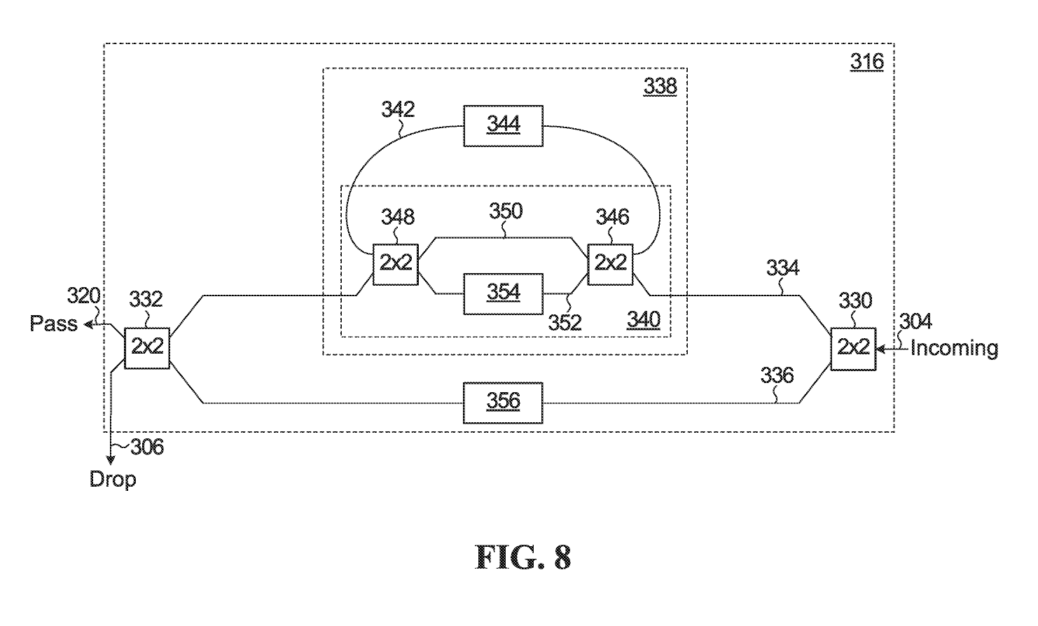

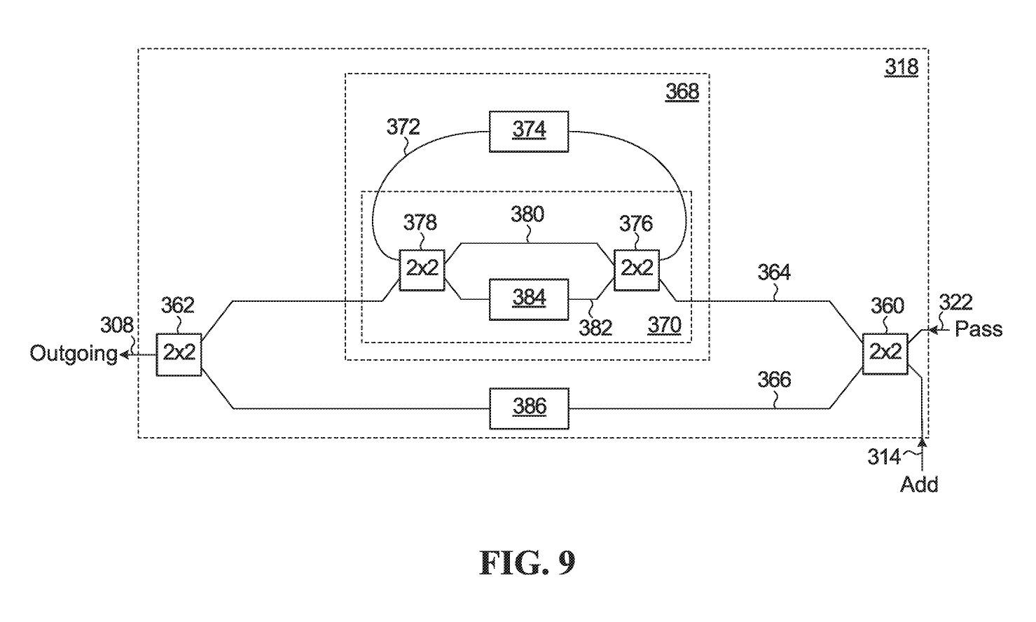

In some embodiments, the first tunable optical filter 228 optically coupled to the first optical path 224 and/or the second tunable optical filter 230 optically coupled to the second optical path 226 may be implemented with a tunable resonator ring filter. Examples of tunable resonator ring filters are discussed later with reference to FIGS. 8 and 9. Depending on the structure of the resonator ring filter that is used, it is possible that the first tunable optical filter 228 and/or the second tunable optical filter 230 may have alternate or additional ports to add or drop channels. For example, if the first tunable optical filter 228 were implemented using a resonator ring filter structure similar to the resonator ring structure 20 shown in FIG. 1B with a first side of the resonator ring filter optically coupled to the first optical path 224 similar to the optical coupling of the resonator ring 22 to the first optical waveguide 24, then the Add and/or Drop ports of another optical waveguide optically coupled to a second side of the resonator ring could serve as alternative or additional Add and/or Drop ports to add and/or drop channels, similar to the Add and Drop ports of the second optical waveguide 28 optically coupled to the resonator ring 22 shown in FIG. 1B. The same is true for the second tunable optical filter 230, which could likewise be implemented with a resonator ring filter. To illustrate this possibility by way of an example, FIG. 6 shows that an additional or alternative Add optical input port 234 could potentially be provided through the first tunable optical filter 228, and an additional or alternative Drop optical output port 232 could potentially be provided through the second tunable optical filter 230.

In some embodiments, the first 2×2 optical coupler 220 and the second 2×2 optical coupler 222 may be implemented with variable directional couplers with a variable coupling efficiency, k, to provide power adjustment capability between the optical input ports of the first optical coupler 220 and the optical output ports of the second optical coupler 222.

In some embodiments, the tunable optical filters 228 and 230 are tunable in terms of bandwidth, center wavelength, or both.

When utilizing a tunable optical filter structure such as the one shown in FIG. 6 to implement an ADM, it may be preferable to avoid having the wavelength band(s) of the add channels overlap with the wavelength band(s) of the drop channels and the transit channels in order to avoid potential collisions. For example, in some embodiments the first tunable optical filter 228 optically coupled to the first optical path 224 and the second tunable optical filter 230 optically coupled to the second optical path 226 may be configured so that a third wavelength band for add channels and a first wavelength band for drop channels are non-overlapping.

Tunable optical filters 228 and 230, optical paths 224 and 226 and 2×2 optical couplers 220 and 222 may be implemented in a silicon photonics fabrication technology in some embodiments.

While the tunable optical filter structure 202 utilizes two tunable optical filters 228 and 230 in a parallel arrangement in the parallel optical paths 224 and 226 of an MZI based optical filter structure to implement the add and drop functionalities of an ADM, in other embodiments a serial arrangement of two tunable optical filters may be utilized to implement add and drop functionalities. In such arrangements, the add and drop functionalities may be separated. For example, in a serial arrangement of tunable optical filters, the drop functionality may be implemented in a first tunable optical filter, with the add functionality implemented in a subsequent tunable optical filter, which means that add channels added via the add functionality of the subsequent tunable optical filter could potentially overlap, in terms of channel wavelength, with drop channels that were dropped via the drop functionality of the first tunable optical filter, without causing a collision problem.

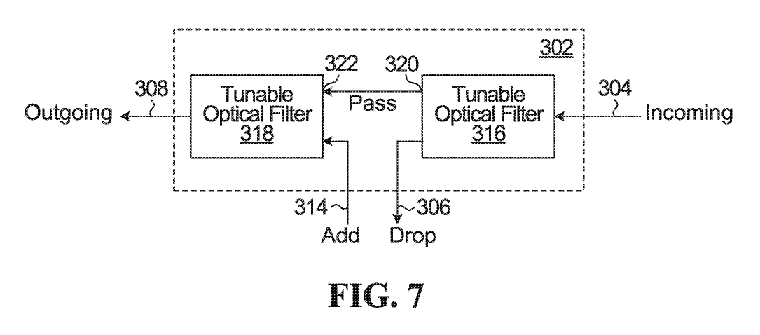

An example of such a serial arrangement will now be discussed with reference to FIG. 7, which is a block diagram of an example of a tunable optical filter structure 302 according to another embodiment of the present invention. The tunable optical filter structure 302 includes an incoming optical input port 304, a drop optical output port 306, an outgoing optical output port 308, an add optical input port 314, a first three-port tunable optical filter 316 for optical drop functionality, and a second three-port tunable optical filter 318 for optical add functionality. The first three-port tunable optical filter 316 has an optical input port optically connected to the incoming optical input port 304, an optical output port optically connected to the drop optical output port 306, and a pass optical output port 320. The second three-port tunable optical filter 318 has a pass optical input port 322 optically connected to the pass optical output port 320 of the first three-port tunable optical filter 316, an optical input port optically connected to the add optical input port 314, and an optical output port optically connected to the outgoing optical output port 308.

In operation, for an incoming optical signal received at the incoming optical input port 304, the first three-port tunable optical filter 316 is controllable to drop a first portion of the incoming optical signal in the first wavelength band to the drop optical output port 306 and to pass a second portion of the incoming optical signal in a second wavelength band to the pass optical output port 320. Similarly, the second three-port tunable optical filter 318 is controllable to pass the second portion of the incoming optical signal in the second wavelength band from its pass optical input port 322 to the outgoing optical output port 308, and to also add an add optical input signal in a third wavelength band from the add optical input port 314 to the outgoing optical output port 308.

In some embodiments, the three-port tunable optical filters 316 and 318 are tunable in terms of bandwidth, center wavelength, or both.

The three-port tunable optical filters 316 and 318 may be implemented in a silicon photonics fabrication technology in some embodiments.

For illustrative purposes, example implementations of the first and second three-port tunable optical filters 316 and 318 will now be discussed with reference to FIGS. 8 and 9.

FIG. 8 is block diagram of an example of a tunable optical filter that may be used in an embodiment of the present invention to implement the first tunable optical filter 316 of the tunable optical filter structure 302 of FIG. 7.

The tunable optical filter 316 shown in FIG. 8 is a tunable Mach-Zehnder Interferometer and Resonator Ring (MZI/RR) hybrid optical filter that includes a MZI structure and a tunable Resonator Ring (RR) filter 338. The MZI structure includes a first optical coupler 330, a second optical coupler 332, and first and second optical paths 334 and 336. The first optical coupler 330 has an optical input port optically connected to the incoming optical input port 304, a first optical output port optically connected to the first optical path 334, and a second optical output port optically connected to the second optical path 336. The second optical coupler 332 has a first optical input port optically connected to the first optical path 334, a second optical input port optically connected to the second optical path 336, a first optical output port optically connected to the pass optical output port 320, and a second optical output port optically connected to the drop optical output port 306. The tunable RR filter 338 is optically coupled to the first optical path 334. The second optical path 336 includes a controllable optical phase shifter 356.

In the illustrated example, the tunable RR filter 338 includes a resonator ring 342 and a variable optical coupler 340 optically coupling the resonator ring 342 to the first optical path 334. The resonator ring 342 includes a wavelength-tuning element 344. The variable optical coupler 340 of the tunable RR filter 338 is based on a MZI structure that includes a third optical coupler 346, a fourth optical coupler 348, a third optical path 350 and a fourth optical path 352. The third optical coupler 346 has a first optical input port optically connected to one end of an optical waveguide of the resonator ring 342, a second optical input port optically connected to the first optical output port of the first optical coupler 330, a first optical output port optically connected to the third optical path 350, and a second optical output port optically connected to the fourth optical path 352. The fourth optical coupler 348 has a first optical input port optically connected to the third optical path 350, a second optical input port optically connected to the fourth optical path 352, a first optical output port optically connected to an opposite end of the optical waveguide of the resonator ring 342, and a second optical output port optically connected to the first optical input port of the second optical coupler 332. The fourth optical path 352 includes a controllable optical phase shifter 354.

In operation, an incoming optical input signal is received at the incoming optical input port 304 and is coupled onto the first and second optical paths 334 and 336 by the first optical coupler 330. The tunable RR filter 338 is tunable to filter an optical signal propagating through the first optical path 334 to cause a first portion of an incoming optical signal in a first wavelength band to be dropped to the drop optical output port 306, and to cause a second portion of the incoming optical signal in a second wavelength band to be passed to the pass optical output port 320.

The controllable optical phase shifter 356 is controllable to adjust a relative optical phase shift between the first optical path 334 and the second optical path 336 in order to control the switching functionality of the MZI structure.

The controllable optical phase shifter 354 of the variable optical coupler 340 is controllable to adjust the optical coupling between the resonator ring 342 and the first optical path 334 by adjusting a relative optical phase shift between the third optical path 350 and the fourth optical path 352. With reference again to FIG. 3, it is noted that varying the coupling efficiency for a resonator ring filter can vary the 3 dB bandwidth of the filter. Accordingly, it should be appreciated that the tunable RR filter 338 may be bandwidth-tunable by varying the variable optical coupling provided by the variable optical coupler 340. For example, in some embodiments, the variable optical coupling provided between the first optical path 334 and the resonator ring 342 by the variable optical coupler 340 may be reduced, in terms of coupling efficiency, in order to increase the 3 dB bandwidth of the tunable RR filter 338, or increased in order to reduce the 3 dB bandwidth of the tunable RR filter 338. In some cases, the tunable optical filter 316 may be configured with a 100 GHz 3 dB bandwidth, which may be able to support channels up to 400 Gbps. It is noted that a 100 GHz 3 dB frequency bandwidth corresponds to ˜1 nm 3 dB wavelength bandwidth.

While the MZI structure of the variable optical coupler 340 includes the controllable optical phase shifter 354 in the fourth optical path 352, in other embodiments the controllable optical phase shifter may be included in the third optical path 350 rather than in the fourth optical path 352. In still other embodiments, the third and fourth optical paths 350 and 352 may both include a controllable optical phase shifter.

In some embodiments, the controllable optical phase shifters 354 and 356 may be implemented with thermo-optical phase shifters or carrier injection optical phase shifters.

In some embodiments, the optical couplers 330, 332, 346 and 348 may be implemented with multimode interference (MMI) couplers or adiabatic couplers.

The total phase change experienced in a resonator ring can be expressed as follows:

φ=φ₀+KL (10)

where φ is the total phase change experienced in the resonator ring, φ₀ accounts for any undesired or unknown initial phase of the resonator ring, K is the propagation constant of the resonator ring and L is the length of the resonator ring. It is noted that the propagation constant K can be expressed in terms of wavelength, λ, or frequency, f, as follows:

$$K = \frac{2 π}{λ} = \frac{2 π f}{c} = \frac{ω}{c} \qquad ( 11 )$$

where c is the speed of light in the waveguide of the ring. It is further noted that for a circular resonator ring with a radius R, the length of the ring, L, can be expressed as follows:

L=2πR (12)

The phase change experienced by an optical signal propagating around the resonator ring 342 can be tuned by the wavelength-tuning element 344 to shift the center wavelength of the resonance for the effective transfer function of the tunable RR filter 338. In some embodiments, the tunable RR filter 338 is configured to allow the center wavelength of the effective transfer function of the tunable RR filter to be swept across substantially the entire C band spectrum.

In some embodiments, the wavelength-tuning element 344 is implemented with a thermo-optical phase shifter or carrier injection optical phase shifter.

Referring again to Equation 4, it has been shown that the FSR of an RR filter can be calculated by the total length of the ring (including the coupler(s) and the ring). In some embodiments, the tunable RR filter 338 may be configured with an FSR of 30 nm to cover the full C band spectrum. In some embodiments, the total length of the tunable RR filter 338 may be in the range of 10-20 micrometers in order to provide an FSR large enough to cover substantially the whole C band spectrum.

FIG. 9 is block diagram of an example of a tunable optical filter that may be used in an embodiment of the present invention to implement the second tunable optical filter 318 of the tunable optical filter structure 302 of FIG. 7.

Similar to the tunable optical filter 316 shown in FIG. 8, the tunable optical filter 318 shown in FIG. 9 is a tunable Mach-Zehnder Interferometer and Resonator Ring (MZI/RR) hybrid optical filter that includes a MZI structure and a tunable Resonator Ring (RR) filter 368. The MZI structure includes a first optical coupler 360, a second optical coupler 362, and first and second optical paths 364 and 366. The first optical coupler 360 has a first optical input port optically connected to the pass optical input port 322, a second optical input port optically connected to the add optical input port 314, a first optical output port optically connected to the first optical path 364, and a second optical output port optically connected to the second optical path 366. The second optical coupler 362 has a first optical input port optically connected to the first optical path 364, a second optical input port optically connected to the second optical path 366, and an optical output port optically connected to the outgoing optical output port 308. The tunable RR filter 338 is optically coupled to the first optical path 364. The second optical path 366 includes a controllable optical phase shifter 386.

In the illustrated example, the tunable RR filter 368 includes a resonator ring 372 and a variable optical coupler 370 optically coupling the resonator ring 372 to the first optical path 364. The resonator ring 372 includes a wavelength-tuning element 374. The variable optical coupler 370 of the tunable RR filter 368 is based on a MZI structure that includes a third optical coupler 376, a fourth optical coupler 378, a third optical path 380 and a fourth optical path 382. The third optical coupler 376 has a first optical input port optically connected to one end of an optical waveguide of the resonator ring 372, a second optical input port optically connected to the first optical output port of the first optical coupler 360, a first optical output port optically connected to the third optical path 380, and a second optical output port optically connected to the fourth optical path 382. The fourth optical coupler 378 has a first optical input port optically connected to the third optical path 380, a second optical input port optically connected to the fourth optical path 382, a first optical output port optically connected to an opposite end of the optical waveguide of the resonator ring 372, and a second optical output port optically connected to the first optical input port of the second optical coupler 362. The fourth optical path 382 includes a controllable optical phase shifter 384.

In operation, a pass optical input signal is received at the pass optical input port 322 and is coupled onto the first and second optical paths 364 and 366 by the first optical coupler 360. An add optical input signal is received at the add optical input port 314. The add optical input signal may include one or more channel wavelengths in a third wavelength band. The tunable RR filter 368 is tunable to filter an optical signal propagating through the first optical path 364 to cause a portion of the pass optical input signal in the second wavelength band, to be passed from the pass optical input port 322 to the outgoing optical output port 308, and to cause a portion of the add optical input signal in the third wavelength band to be added to an outgoing optical output signal at the outgoing optical output port 308.

In some embodiments, the first and second tunable filters 316 and 318 are configured to have the third wavelength band, e.g., the Add wavelength band, at least partially overlap with the first wavelength band, e.g. the Drop wavelength band.

It is noted that the implementation and operation of the controllable optical phase shifters 386 and 384 and the tunable RR filter 368 shown in FIG. 9 are similar to that of the controllable optical phase shifters 356 and 354 and the tunable RR filter 338 shown in FIG. 8 and therefore further implementation and operational details regarding those components are omitted here.

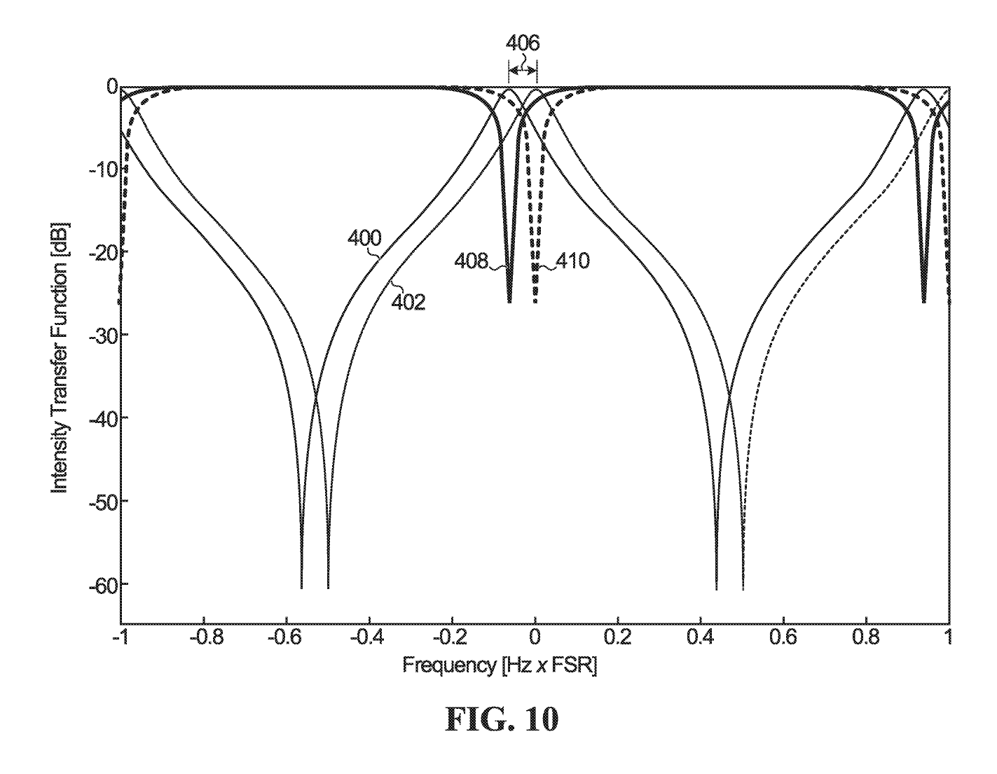

FIG. 10 is a plot of an example intensity transfer function of the tunable optical filter 316 of FIG. 8 showing wavelength tuning. In FIG. 10, the intensity transfer functions for Drop (from Incoming optical input port 304 to Drop optical output port 306) and for Pass (from Incoming optical input port 304 to Pass optical output port 320) are indicated at 400 and 408, respectively, for a first center wavelength tuning, and again at 402 and 410, respectively, for a second center wavelength tuning. In the illustrated example, the difference between the first wavelength tuning and the second wavelength tuning was accomplished by controlling the wavelength tuning element 344 to introduce a π/8 phase shift in the resonator ring 342 of the tunable RR filter 338. As can be seen the rejection ratio is quite good, and as indicated at 406, the π/8 phase shift changes the center wavelength by as much as 0.0625×FSR. In general, this relation is not expected to be linear. It is noted that the results plotted in FIG. 10 assume a 0.06 dB coupling loss, 0.8 coupling efficiency for the variable optical coupler 340, a 0.2 dB resonator ring loss and 50% coupling efficiencies for the first and second optical couplers 330 and 332.

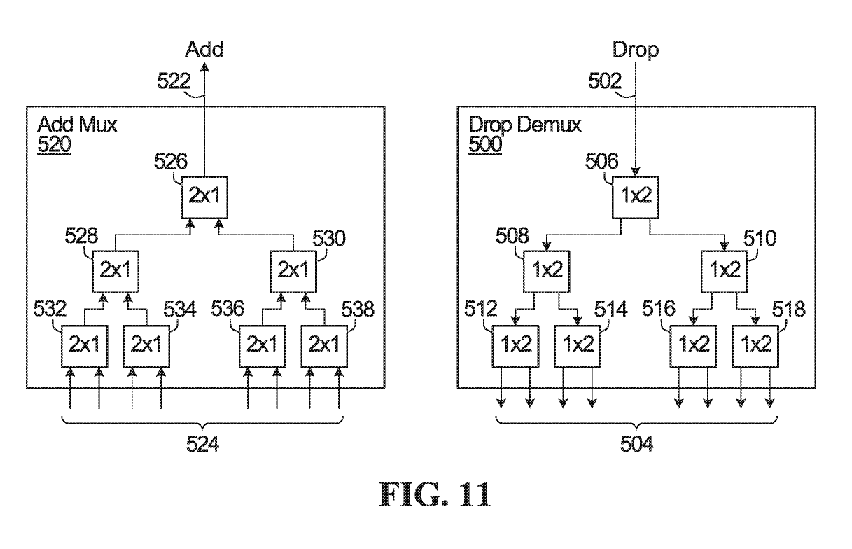

Referring again to FIG. 5, various examples of structures that may be used to implement the drop demultiplexer 110 and the add multiplexer 116 will now be discussed with reference to FIGS. 11 to 14.

FIG. 11 is a block diagram of an example demultiplexer 500 for local optical drop ports and an example multiplexer 520 for local optical add ports according to an embodiment of the present invention.

The demultiplexer 500 has a drop optical input port 502 and eight local drop optical output ports 504. In the illustrated example, the demultiplexer includes seven 1×2 optical elements 506, 508, 510, 512, 514, 516 and 518 arranged in a cascade between the drop optical input port 502 and the local drop optical output ports 504.

In operation, the drop optical input port 502 receives a drop optical input signal, which may include a dropped first portion of an incoming optical signal in a first wavelength band. In some embodiments, the 1×2 optical elements 506, 508, 510, 512, 514, 516 and 518 may be implemented with 1×2 optical splitters, such as passive 1×2 optical splitters, which, in some cases, may be implemented using integrated silicon photonic MZI elements. In such embodiments, the 1×2 optical splitters distribute the dropped first portion of the incoming optical signal in the first wavelength band among the multiple local drop optical output ports 504. In other embodiments, the 1×2 optical elements 506, 508, 510, 512, 514, 516 and 518 may be implemented with 1×2 optical switches configured as variable splitters controllable to selectively distribute the dropped first portion of the incoming optical signal in the first wavelength band among the local drop optical output ports 504. For example, in some embodiments, the 1×2 optical switches may be controlled to selectively switch their respective optical input signal between one of their two outputs, while in other embodiments they may be controlled to split their respective optical input, possibly unequally, between their two optical outputs.

The multiplexer 520 has an add optical output port 522, eight local add optical input ports 524, and includes seven 2×1 optical combiners 526, 528, 530, 532, 534, 536 and 538 arranged in a cascade between the local add optical input ports 524 and the add optical output port 522. In some embodiments, the 2×1 optical combiners may be implemented using integrated silicon photonic MZI elements.

In operation, the local add optical input ports 524 receive local add optical input signals, which may be located in a third wavelength band. In some embodiments, the 2×1 optical elements 526, 528, 530, 532, 534, 536 and 538 may be implemented with 2×1 optical combiners, such as passive 2×1 optical combiners. In such embodiments, the 2×1 optical combiners combine the local add optical input signals from the local add optical input ports 524 into an add optical input signal at the add optical output port 522. In other embodiments, the 2×1 optical elements 526, 528, 530, 532, 534, 536 and 538 may be implemented with 2×1 optical switches configured as variable combiners controllable to selectively combine the local add optical input signals in the third wavelength band from the multiple local add optical input ports into the add optical input signal. For example, in some embodiments, the 2×1 optical switches may be controlled to select between their respective optical inputs, while in other embodiments they may be controlled to combine, possibly unequally, their respective optical inputs.

While the demultiplexer 500 and the multiplexer 520 each have eight local ports in the illustrated example depicted in FIG. 11, more generally they may include any number of local ports, and not necessarily in equal number. For example, in some embodiments there may be more local add input ports than local drop output ports, while in other embodiments there may be more local drop output ports than local add input ports.

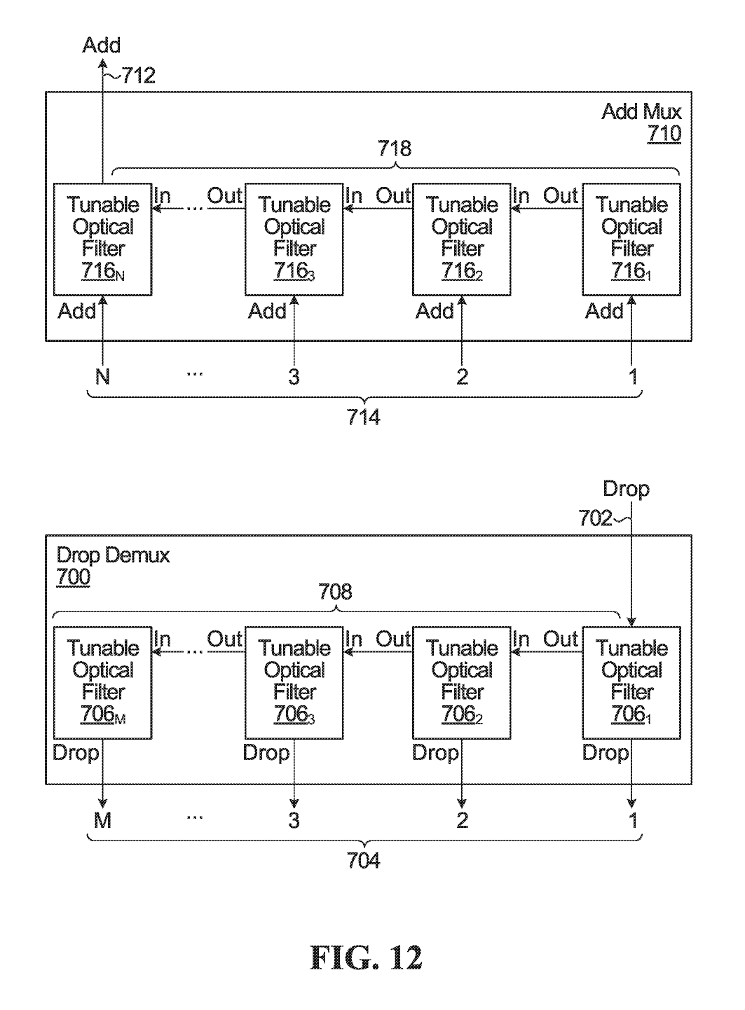

FIG. 12 is a block diagram of an example demultiplexer 700 with cascaded three-port tunable optical filters for local optical drop ports and an example multiplexer 710 with cascaded three-port tunable optical filters for local optical add ports according to an embodiment of the present invention.

The demultiplexer 700 has a drop optical input port 702 and M local drop optical output ports 704. The demultiplexer 700 includes M three-port tunable optical filters 706₁, 706₂, 706₃ . . . 706_{M} arranged in a cascade 708. The first tunable optical filter 706₁ in the cascade 708 has an optical input port optically connected to the drop optical input port 702, an optical output port optically connected to an optical input port of the next tunable optical filter 706₂ in the cascade 708, and a drop optical output port optically connected to the first local drop optical output port. Each successive tunable optical filter in the cascade 708 has an optical input port optically connected to the optical output port of a preceding tunable optical filter in the cascade, an optical output port optically connected to a succeeding tunable optical filter in the cascade (with the exception of the last tunable optical filter in the cascade), and a drop optical output port optically connected to a respective local drop optical output port.

In operation, the first tunable optical filter 706₁ in the cascade 708 receives a drop optical input signal, which may include a dropped first portion of an incoming optical signal in a first wavelength band, and each tunable optical filter in the cascade 708 is tunable to drop a respective portion of the drop optical input signal to a respective local drop optical output port of the M local drop optical output ports 704 and to pass a remaining portion onto the next tunable optical filter in the cascade 708.

In some embodiments, each tunable optical filter 706₁, 706₂, 706₃, . . . , 706_{M} in the cascade 708 is wavelength-tunable to drop a respective channel wavelength in the first wavelength band.

The multiplexer 710 has an add optical output port 712 and N local add optical input ports 714. The multiplexer 710 includes N tunable optical filters 716₁, 716₂, 716₃ . . . 706_{N} arranged in a cascade 718. The first tunable optical filter 716₁ in the cascade 718 has an add optical input port optically connected to a respective local add optical input port of the N local add optical input ports 714, and an optical output port optically connected to the next tunable optical filter 716₂ in the cascade 718. Each successive tunable optical filter in the cascade 718 has an optical input port optically connected to the optical output port of a preceding tunable optical filter in the cascade 718, an add optical input port optically connected to a respective local add optical input port of the N local add optical input ports 714, and an optical output port optically connected to a succeeding tunable optical filter in the cascade, with the exception of the last tunable optical filter 716_{N}, which instead has its optical output port optically connected to the add optical output port 712.

In operation, the local add optical input ports 714 receive local add optical input signals, which may be located in a third wavelength band. Each tunable optical filter 716₁, 716₂, 716₃, . . . , 716_{N} in the cascade 718 is tunable to add a respective local add optical input signal in a third wavelength band from its respective local add optical input port to an optical signal received from the previous tunable optical filter in the cascade 718 and output the result to the next tunable optical filter in the cascade 718, with the last tunable optical filter 716_{N} in the cascade 718 outputting its resulting optical output signal to the add optical output port 712.

In some embodiments, each tunable optical filter 716₁, 716₂, 716₃, . . . , 716_{N} in the cascade 718 is wavelength-tunable to add a respective channel wavelength in the third wavelength band.

In some embodiments, there are an equal number of local add ports 714 and local drop ports 704, i.e. N=M, while in other embodiments there are an unequal number of local add ports 714 and local drop ports 704, i.e. N≠M, with N being less than M in some cases, while in others N is greater than M.

In some embodiments, the tunable optical filters 706₁ to 706_{M} of the demultiplexer 700 may be implemented with MZI/RR hybrid optical filter structures similar to that of the three-port tunable optical filter 316 shown in FIG. 8. For example, in one embodiment, the tunable optical filters 706₁ to 706_{M} are each implemented with the same MZI/RR hybrid optical filter structure as the three-port tunable optical filter 316 except that the variable optical coupler 340 is replaced with a fixed 2×2 optical coupler.

Similarly, in some embodiments, the tunable optical filters 716₁ to 716_{M} of the multiplexer 710 may be implemented with MZI/RR hybrid optical filter structures similar to that of the three-port tunable optical filter 318 shown in FIG. 9. For example, in one embodiment, the tunable optical filters 716₁ to 716_{M} are each implemented with the same MZI/RR hybrid optical filter structure as the three-port tunable optical filter 318 except that the variable optical coupler 370 is replaced with a fixed 2×2 optical coupler.

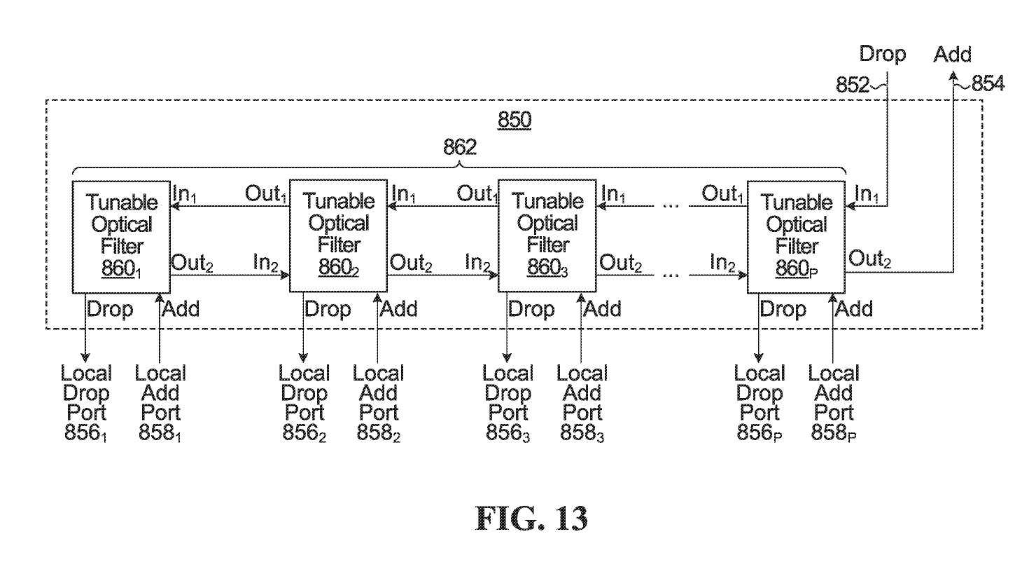

FIG. 13 is a block diagram of an example of a multiplexing and demultiplexing structure 850 with cascaded tunable optical filters according to an embodiment of the present invention.

The demultiplexer and multiplexer structure 850 has a drop optical input port 852, an add optical output port 854, P local drop optical output ports 856₁, 856₂, 856₃, . . . 856_{P}, and P local add optical input ports 858₁, 858₂, 858₃, . . . , 858_{P}. The demultiplexer and multiplexer structure 850 includes P six-port tunable optical filters 860₁, 860₂, 860₃ . . . 860_{P} arranged in a cascade 862.

The last six-port tunable optical filter 860_{P} in the cascade 862 has a first optical input port In₁ optically connected to the drop optical input port 852, a first optical output port Out₁ optically connected to a first optical input port of the previous tunable optical filter in the cascade 862, a second optical input port In₂ optically connected to a second optical output port of the previous tunable optical filter in the cascade 862, a second optical output port Out₂ optically connected to the add optical output port 854, a drop optical output port Drop optically connected to the last local drop optical output port 856_{P}, and an add optical input port Add optically connected to the last local add optical input port 858_{P}.

Similarly, each preceding tunable optical filter in the cascade 862, with the exception of the first tunable optical filter 860₁, has a first optical input port In₁ optically connected to the first optical output port of the next tunable optical filter in the cascade 862, a first optical output port Out₁ optically connected to a first optical input port of the previous tunable optical filter in the cascade 862, a second optical input port In₂ optically connected to the second optical output port of the previous tunable optical filter in the cascade 862, a second optical output port Out₂ optically connected to the second optical input port of the next tunable optical filter in the cascade 862, a drop optical output port Drop optically connected to a respective local drop optical output port, and an add optical input port Add optically connected to a respective local add optical input port. The first tunable optical filter 860₁ in the cascade has the first optical input port In1 and the second optical output port Out₂, but omits the first optical output port Out1 and the second optical input port In₁.

In operation, the first optical input port In₁ of the last tunable optical filter 860_{P} in the cascade 862 receives a drop optical input signal from the drop optical input port 852. The drop optical input signal may include a dropped first portion of an incoming optical signal in a first wavelength band. Each tunable optical filter in the cascade 862 is tunable to drop a respective portion of the drop optical input signal to a respective local drop optical output port of the P local drop optical output ports and to pass a remaining portion onto the first optical input In₁ of the next tunable optical filter in the cascade 862. Similarly, the tunable optical filters 860₁, 860₂, 860₃, . . . , 860_{P} may receive local add optical input signals from the local add optical input ports 858₁, 858₂, 858₃, . . . , 858_{P}. The local add optical input signals may be located in a third wavelength band. Each tunable optical filter 860₁, 860₂, 860₃, . . . , 860_{P} in the cascade 862 is tunable to add a respective local add optical input signal in a third wavelength band from its respective local add optical input port to an optical signal received via its second optical input port In₂ from the previous tunable optical filter in the cascade 862 and to output the result to its second optical output port Out₂, with the last tunable optical filter 860_{P} in the cascade 862 outputting its resulting optical output signal to the add optical output port 854.

This architecture shares the same filtering for Add and Drop purposes, and hence reduces the total number of filtering modules employed in the AON architecture. This architecture also potentially provides colorless-directionless-contentionless (CDC) functionality (for a two degree optical node) with potentially no channel size/bandwidth limitations. Each tunable filter module can potentially be tuned to desired wavelengths/band to be added/dropped. It can therefore support colorless functionality and also potentially provides the ability to adjust the power level while dropping/adding channels.

In some embodiments, each tunable optical filter 860₁, 860₂, 860₃, . . . , 860_{P} in the cascade 862 is wavelength-tunable to drop a respective channel wavelength in the first wavelength band.

In some embodiments, each tunable optical filter 860₁, 860₂, 860₃, . . . , 860_{P} in the cascade 862 is wavelength-tunable to add a respective channel wavelength in the third wavelength band.

In the embodiment depicted in FIG. 13, the demultiplexing and multiplexing structure 850 includes an equal number of local add and drop ports. In some embodiments, there may be an unequal number of local add and drop ports.

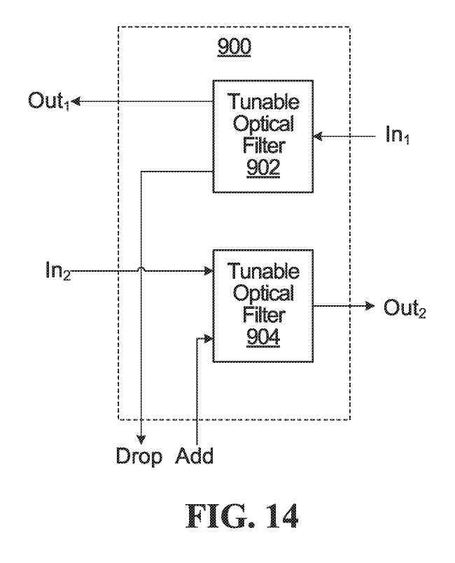

FIG. 14 is a block diagram of an example of a six-port tunable optical filter structure 900 that may be used to implement the six-port tunable optical filters 860₁, 860₂, 860₃, . . . , 860_{P} in the multiplexing and demultiplexing structure 850 of FIG. 13.

The six-port tunable optical filter structure 900 has a first optical input port In₁, a first optical output port Out₁, a second optical input port In₂, a second optical output port Out₂, a drop optical output port Drop, and an add optical input port Add. The six-port tunable optical filter structure 900 includes two three-port tunable optical filters 902 and 904. The first three-port tunable optical filter 902 has an optical input port optically connected to the first optical input port In₁, a first optical output port optically connected to the first optical output port Out₁, and a second optical output port optically connected to the drop optical output port Drop. Similarly, the second three-port tunable optical filter 904 has a first optical input port optically connected to the second optical input port In₂, a second optical input port optically connected to the add optical input port Add, and an optical output port optically connected to the second optical output port Out₂.

In operation, for an optical signal received at the first optical input port In₁, the first three-port tunable optical filter 902 is controllable to drop a respective portion of the optical signal in the first wavelength band to the local drop optical output port Drop and to pass a second portion of the optical signal to the first optical output port Out₁. Similarly, the second three-port tunable optical filter 904 is controllable to add a respective local add optical input signal in a third wavelength band from the local add optical input port Add to an optical signal received at the second optical input port In₂ and to output the result to the second optical output port Out₂.

It is noted that the three-port tunable optical filters 902 and 904 may be implemented with MZI/RR hybrid filter structures such as the MZI/RR hybrid optical filter structures 316 and 318 shown in FIGS. 8 and 9, respectively.

In some embodiments, the three-port tunable optical filters 902 and 904 are tunable in terms of bandwidth, center wavelength, or both.

The three-port tunable optical filters 902 and 904 may be implemented in a silicon photonics fabrication technology in some embodiments.

It is noted that the example multiplexers and demultiplexers shown in FIGS. 11 to 14 can potentially support colorless functionality, and can potentially adjust the power levels of local add and drops channels by using variable optical couplers to implement the first and second optical couplers in the MZI structures. In this context, colorless functionality means that a local port can potentially output (drop) or receive (add) any wavelength (color) of light, and hence is “colorless”. It is also noted that all of the example multiplexers and demultiplexers shown in FIGS. 13 to 18 can potentially support gridless architectures and strategies, where channel bandwidth and/or spacing is not fixed and may change, as the example multiplexers and demultiplexers can potentially be tuned to accommodate different channel center wavelengths and bandwidths.

While FIGS. 11 to 14 show examples of multiplexers and demultiplexers, which may be used to implement the multiplexer 116 and the demultiplexer 110 of the apparatus shown in FIG. 5, it will be appreciated that embodiments of the present invention are not limited these particular examples. Other multiplexer and/or demultiplexer structures may be used in other embodiments.

For example, in some embodiments passive splitters may be used for multiplexing and/or demultiplexing. In such embodiments, local add channels may be combined by a cascade of passive splitter functioning as passive combiners and fed into an add optical output port and vice versa for local drop channels. In some cases, the use of passive splitters/combiners may need amplifications which can be provided either before or after the local Add/Drop multiplexing and demultiplexing section of the AON node apparatus (independent of pass/transit channels). This type of solution may be well suited for implementations with a limited number of local add and drop ports and can potentially be implemented at a relatively low cost. In addition, colorless functionality can be supported.

In other embodiments, the multiplexing and demultiplexing functionality for local add and drop channels is implemented with an Array Wave Guide (AWG) based structure, with a first AWG for demultiplexing local drop channels and a second AWG for multiplexing local add channels. In this type of structure, insertion loss is potentially reduced compared to the passive splitter/combiner structure described above, but the structure is not colorless.

In still other embodiments, a photonic integrated circuit (PIC) switch fabric may be included after an AWG based structure that includes a first AWG for demultiplexing local drop channels and a second AWG for multiplexing local add channels. The addition of the PIC switch fabric allows the resulting structure to potentially support colorless functionality since the outputs of the two AWGs can potentially be selectively switched among the available add and drop ports through the PIC switch fabric. However, this colorless functionality comes at the potential expense of some increased insertion loss and/or potential control challenges.

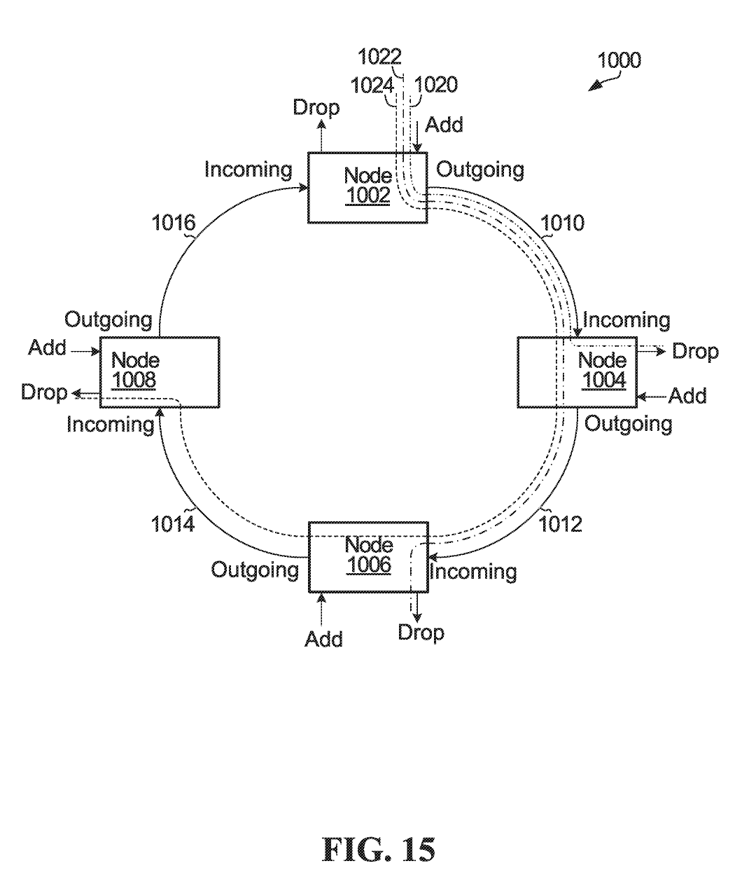

An example ring network that includes AON optical nodes according to an embodiment of the present invention will now be discussed with reference to FIG. 15, which is a block diagram of an example of a uni-directional optical ring network 1000 with multiple optical nodes 1002, 1004, 1006, and 1008 having optical add-drop functionality according to an embodiment of the present invention. Each of the optical nodes 1002, 1004, 1006 and 1008 has an Add optical input port, a Drop optical output port, an Outgoing optical output port and an Incoming optical input port. The Outgoing optical output port of the optical node 1002 is optically connected to the Incoming optical input port of optical node 1004 through an optical waveguide 1010. The Outgoing optical output port of the optical node 1004 is optically connected to the Incoming optical input port of optical node 1006 through an optical waveguide 1012. The Outgoing optical output port of the optical node 1006 is optically connected to the Incoming optical input port of optical node 1008 through an optical waveguide 1014. The Outgoing optical output port of the optical node 1008 is optically connected to the Incoming optical input port of optical node 1002 through an optical waveguide 1016.

The optical waveguides 1010, 1012, 1014 and 1016 may be implemented with any type of optical waveguide medium. In some embodiments, one or more of the optical waveguides 1010, 1012, 1014 and 1016 may be implemented with optical fiber.

For illustrative purposes, FIG. 15 shows an example of local add channel wavelengths/bands 1020, 1022 and 1024 being added at optical node 1002 and dropped at optical nodes 1004, 1006 and 1008 respectively. In particular, the optical node 1002 adds the local add channel wavelengths/bands 1020, 1022 and 1024 to an outgoing optical output signal at its Outgoing optical output port. The outgoing optical output signal containing the channel wavelengths/bands 1020, 1022 and 1024 propagates over optical waveguide 1010 to the Incoming optical input port of the optical node 1004.

The optical node 1004 is configured to receive the outgoing optical output signal as an incoming optical input signal at its Incoming optical port, to drop a first portion of the incoming optical input signal containing the channel wavelengths/band 1020 to its local Drop output port, and to pass a second portion of the incoming optical input signal containing the channel wavelengths/bands 1022 and 1024 to its Outgoing optical output port as part of an outgoing optical output signal. The outgoing optical output signal containing the channel wavelengths/bands 1022 and 1024 propagates over optical waveguide 1012 to the Incoming optical input port of the optical node 1006.

The optical node 1006 is configured to receive the outgoing optical output signal as an incoming optical input signal at its Incoming optical port, to drop a first portion of the incoming optical input signal containing the channel wavelengths/band 1022 to its local Drop output port, and to pass a second portion of the incoming optical input signal containing the channel wavelengths/band 1024 to its Outgoing optical output port as part of an outgoing optical output signal. The outgoing optical output signal containing the channel wavelengths/band 1024 propagates over optical waveguide 1014 to the Incoming optical input port of the optical node 1008.

The optical node 1008 is configured to receive the outgoing optical output signal as an incoming optical input signal at its Incoming optical port and to drop a first portion of the incoming optical input signal containing the channel wavelengths/band 1024 to its local Drop output port.

Note that in the illustrated example, optical node 1002 can use any channel wavelength in channel wavelengths/band 1022 to directly communicate with optical node 1006 because optical node 1004 is configured with a pass band that includes the channel wavelengths/band 1022. That is, the optical node 1004 can be said to be “transparent” to the channel wavelengths/band 1022. As noted earlier with reference to Equation 9, by utilizing tunable optical filtering to implement ADM functionality according to an embodiment of the present invention, there is a trade-off between losses incurred by incoming transit/pass channel wavelengths/bands and local add and drop channels wavelengths/bands. For the purposes of link budget optimization it may be desirable to exploit this trade-off so that losses experienced in the transit/pass band are reduced or minimized in trade for increased losses incurred by locally added/dropped channels.

As will be appreciated, although FIG. 15 only depicts an example of adding channel wavelengths/bands through optical node 1002 and respective drops through optical nodes 1004, 1006 and 1008, more generally add and/or drop channels may be added and/or dropped through any of the optical nodes 1002, 1004, 1006 and 1008.

While FIG. 15 indicates that the optical ring network 1000 is uni-directional, embodiments of the present invention are not limited to uni-directional optical ring networks.

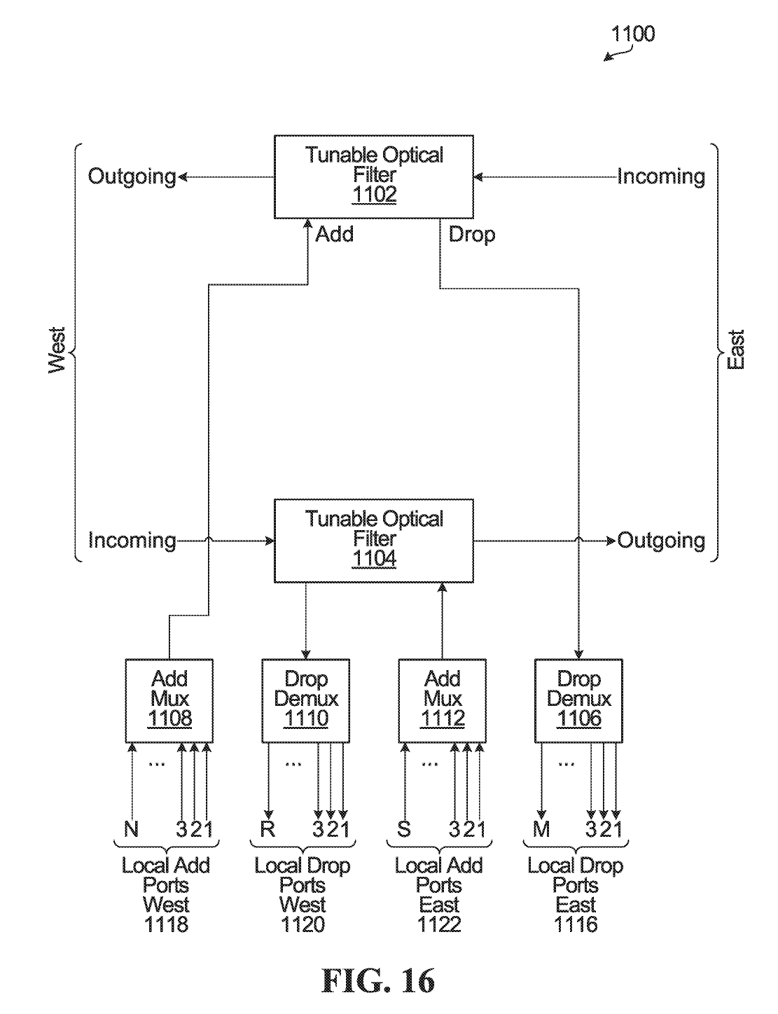

Example apparatuses and structures to support bi-directional or two degree ADM functionality will now be discussed with reference to FIGS. 16 to 18.

FIG. 16 is a block diagram of an example of an apparatus 1100 according to an embodiment of the present invention that provides two degree or bi-directional ADM functionality.

Similar to the apparatus 100 shown in FIG. 5, the apparatus 1100 includes a first tunable optical filter 1102 having an Incoming optical input port for a first direction, a Drop optical output port optically connected to a first drop demultiplexer 1106, an Add optical input port optically connected to a first add multiplexer 1108, and an Outgoing optical output port for a second direction. However, the apparatus 1100 further includes a second tunable optical filter 1104 having an Incoming optical input port for the second direction, a Drop optical output port optically connected to a second drop demultiplexer 1110, an Add optical input port optically connected to a second add multiplexer 1112, and an Outgoing optical output port for the first direction. The first drop demultiplexer 1106 has M local drop optical output ports 1116, the first add multiplexer 1108 has N local add optical input ports 1118, the second drop demultiplexer 1110 has R local drop optical output ports 1120, and the second add multiplexer 1112 has S local add optical input ports 1122.

For illustrative purposes the first and second directions are designated as “East” and “West”, respectively, in FIG. 16. However, references to “East” and “West” do not of course necessarily imply east or west, but simply two directions or degrees that the apparatus receive and transmit optical signals.

In operation, to implement drop functionality for the first direction, the Incoming optical input port of the first tunable optical filter 1102 receives an incoming optical signal from the first direction (East) and the first tunable optical filter 1102 is controllable to drop a first portion of the incoming optical signal in a first wavelength band for the first direction to its Drop optical output port and to pass a second portion of the incoming optical signal in a second wavelength band for the second direction to its Outgoing optical output port. The first drop demultiplexer 1106 distributes the dropped first portion of the incoming optical signal in the first wavelength band for the first direction among the local drop optical output ports 1116. To implement add functionality for the second direction (West), the first add multiplexer 1108 is configured to combine local add optical input signals in a third wavelength band for the second direction from the local add optical input ports 1118 into an add optical input signal for the second direction, and the first tunable optical filter 1102 is configured to add the add optical input signal for the second direction to an outgoing optical signal for the second direction at its Outgoing optical output port.

Similarly, to implement drop functionality for the second direction, the Incoming optical input port of the second tunable optical filter 1104 receives an incoming optical signal from the second direction (West) and the second tunable optical filter 1104 is controllable to drop a first portion of the incoming optical signal in a first wavelength band for the second direction to its Drop optical output port and to pass a second portion of the incoming optical signal in a second wavelength band for the first direction to its Outgoing optical output port. The second drop demultiplexer 1110 distributes the dropped first portion of the incoming optical signal in the first wavelength band for the second direction among the local drop optical output ports 1120. To implement add functionality for the first direction, the second add multiplexer 1112 is configured to combine local add optical input signals in a third wavelength band for the first direction from the local add optical input ports 1122 into an add optical input signal for the first direction, and the second tunable optical filter 1104 is configured to add the add optical input signal for the first direction to an outgoing optical signal for the first direction at its Outgoing optical output port.

The tunable optical filters 1102 and 1104, the drop demultiplexers 1106 and 1110, and the add multiplexers 1108 and 1112 may be implemented in a silicon photonics fabrication technology in some embodiments.

As in other embodiments, each of the tunable optical filters 1102 and 1104, the drop demultiplexers 1106 and 1110, and the add multiplexers 1108 and 1112 may be tunable in terms of bandwidth, center wavelength, or both.

In some embodiments, the first tunable optical filter 1102 is configured so that the third wavelength band for the second direction and the first wavelength band for the first direction are non-overlapping. In other embodiments, the first tunable optical filter 1102 is configured so that the third wavelength band for the second direction and the first wavelength band for the first direction at least partially overlap. Similarly, in some embodiments, the second tunable optical filter 1104 is configured so that the third wavelength band for the first direction and the first wavelength band for the second direction are non-overlapping. In other embodiments, the second tunable optical filter 1104 is configured so that the third wavelength band for the first direction and the first wavelength band for the second direction at least partially overlap.

It will be appreciated that, in some embodiments, each of the tunable optical filters 1102 and 1104 may be implemented with structures such as those shown in FIGS. 8 and 9, while the drop demultiplexers 1106 and 1110 and the add multiplexers 1108 and 1112 may be implemented with structures such as those shown in FIGS. 11 to 14.

In some embodiments, the components that provide the add, drop and/or pass through functionality of the apparatuses described herein may be integrated into a single module. In other embodiments, some of the components may be implemented as separate modules that may be optically coupled together by optical fiber or some other form of optical waveguide to form the apparatus.

For example, with reference to FIG. 4, in some embodiments the tunable optical filter 82 and the drop demultiplexer 90 may be integrated into a single module, while in other embodiments they may be implemented as separate modules. Similarly, with reference to FIG. 5, the four-port tunable optical filter 102 may be implemented as a first module and the add multiplexer 116 and the drop demultiplexer 110 may be implemented together in a second module. In other cases, add multiplexer 116 and the drop demultiplexer 110 may themselves be implemented in separate modules. With reference to FIG. 7, it should be apparent that in some embodiments the four-port tunable optical filter 302 may itself be implemented as a single module, while in other embodiments it may be implemented with two separate three-port tunable optical filter modules that are optically coupled as shown in FIG. 7.

Implementing the apparatuses in a modular manner as described above can provide flexibility in terms of configurability when initially deploying the apparatus in an optical node, as well as potentially allowing re-configurability to accommodate future upgrades and/or changing network needs. For example, an apparatus may be initially deployed with an add multiplexer module for one degree based on a power splitter architecture that can later be replaced with an add multiplexer module based on a cascade of tunable optical filters, such as the add multiplexer 710 shown in FIG. 12.

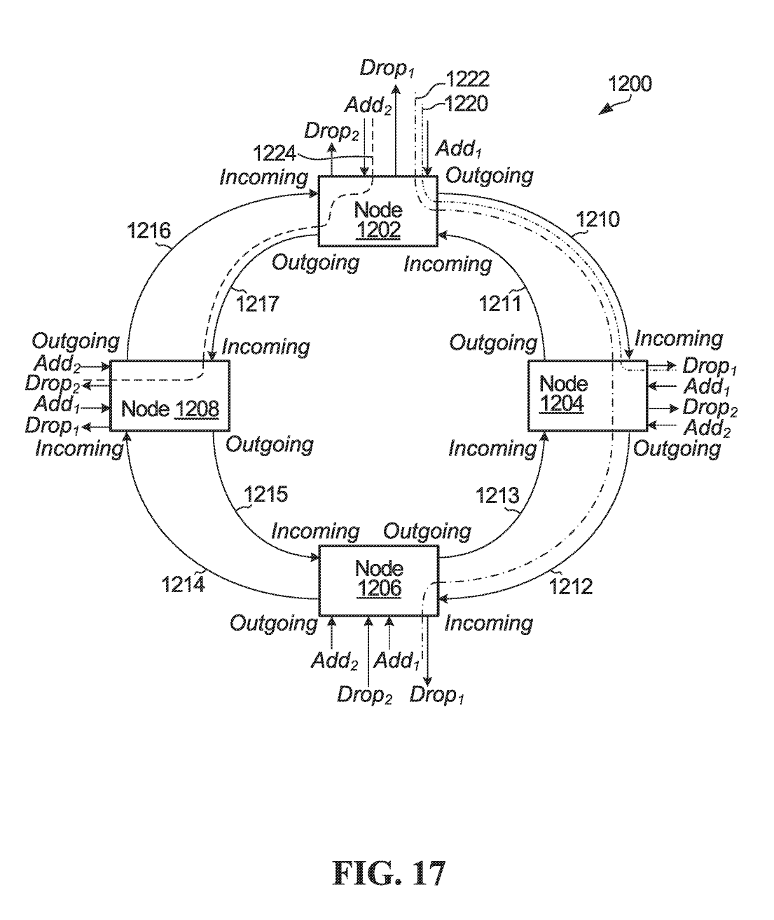

FIG. 17 is a block diagram of an example of a bi-directional optical ring network 1200 with multiple optical nodes 1202, 1204, 1206 and 1208 having optical add-drop functionality according to an embodiment of the present invention.

Each of the optical nodes 1202, 1204, 1206 and 1208 has an Add optical input port, a Drop optical output port, an Outgoing optical output port and an Incoming optical input port for each of two directions (clockwise and counter clockwise in the illustrated example).

The Outgoing optical output port of the optical node 1202 for the clockwise direction is optically connected to the Incoming optical input port of optical node 1204 for the clockwise direction through an optical waveguide 1210. The Outgoing optical output port of the optical node 1204 for the clockwise direction is optically connected to the Incoming optical input port of optical node 1206 for the clockwise direction through an optical waveguide 1212. The Outgoing optical output port of the optical node 1206 for the clockwise direction is optically connected to the Incoming optical input port of optical node 1208 for the clockwise direction through an optical waveguide 1214. The Outgoing optical output port of the optical node 1208 for the clockwise direction is optically connected to the Incoming optical input port of optical node 1202 for the clockwise direction through an optical waveguide 1216.

In the counter clockwise direction, the Outgoing optical output port of the optical node 1202 for the counter clockwise direction is optically connected to the Incoming optical input port of optical node 1208 for the counter clockwise direction through an optical waveguide 1217. The Outgoing optical output port of the optical node 1208 for the counter clockwise direction is optically connected to the Incoming optical input port of optical node 1206 for the counter clockwise direction through an optical waveguide 1215. The Outgoing optical output port of the optical node 1206 for the counter clockwise direction is optically connected to the Incoming optical input port of optical node 1204 for the counter clockwise direction through an optical waveguide 1213. The Outgoing optical output port of the optical node 1204 for the counter clockwise direction is optically connected to the Incoming optical input port of optical node 1202 for the counter clockwise direction through an optical waveguide 1211.

The optical waveguides 1210, 1211, 1212, 1213, 1214, 1215, 1216 and 1217 may be implemented with any type of optical waveguide medium. In some embodiments, one or more of the optical waveguides 1210, 1211, 1212, 1213, 1214, 1215, 1216 and 1217 may be implemented with optical fiber.

For illustrative purposes, FIG. 17 shows an example of local add channel wavelengths/bands 1220, 1222 and 1224 being added at optical node 1202 and dropped at optical nodes 1204, 1206 and 1208 respectively, with the local add channel wavelengths/bands 1220 and 1222 being added in the clockwise direction and channel wavelengths/band 1224 being added in the counter clockwise direction. In particular, the optical node 1202 adds the local add channel wavelengths/bands 1220 and 1222 from its local add optical input port Add, for the clockwise direction to an outgoing optical output signal at its Outgoing optical output port for the clockwise direction and adds the local add channel wavelengths/band 1224 from its local add optical input port Add₂ for the counter clockwise direction to an outgoing optical output signal at its Outgoing optical output port for the counter clockwise direction.

In the clockwise direction, the outgoing optical output signal containing the channel wavelengths/bands 1220 and 1222 propagates in the clockwise direction around the ring 1200 over optical waveguide 1210 to the Incoming optical input port of the optical node 1204 for the clockwise direction.

The optical node 1204 is configured to receive the outgoing optical output signal as an incoming optical input signal at its Incoming optical port for the clockwise direction, to drop a first portion of the incoming optical input signal containing the channel wavelengths/band 1220 to its local Drop output port Drop₁ for the clockwise direction, and to pass a second portion of the incoming optical input signal containing the channel wavelengths/bands 1222 to its Outgoing optical output port for the clockwise direction as part of an outgoing optical output signal for the clockwise direction. The outgoing optical output signal containing the channel wavelengths/bands 1222 propagates in the clockwise direction of the optical ring 1200 over optical waveguide 1212 to the Incoming optical input port of the optical node 1206 for the clockwise direction.

The optical node 1206 is configured to receive the outgoing optical output signal as an incoming optical input signal at its Incoming optical port for the clockwise direction and to drop a first portion of the incoming optical input signal containing the channel wavelengths/band 1222 to its local Drop output port Drop₁ for the clockwise direction.

In the counter clockwise direction, the outgoing optical output signal containing the channel wavelengths/band 1224 propagates in the counter clockwise direction around the ring 1200 over optical waveguide 1217 to the Incoming optical input port of the optical node 1208 for the counter clockwise direction.

The optical node 1208 is configured to receive the outgoing optical output signal as an incoming optical input signal at its Incoming optical port for the counter clockwise direction and to drop a first portion of the incoming optical input signal containing the channel wavelengths/band 1224 to its local Drop output port Drop₂ for the counter clockwise direction.

Note that in the illustrated example, optical node 1202 can use any channel wavelength in channel wavelengths/band 1222 to directly communicate with optical node 1206 because optical node 1204 is configured with a pass band that includes the channel wavelengths/band 1222. However, due to the bi-directional functionality of the optical ring network 1200, rather than having to communicate with optical node 1208 through optical nodes 1204 and 1206, the optical node 1202 may instead communicate directly with optical node 1208 in the counter clockwise direction of the optical ring 1200, thereby reducing the path length and potentially the losses incurred.

As will be appreciated, although FIG. 17 only depicts an example of adding channel wavelengths/bands through optical node 1202 and respective drops through optical nodes 1204, 1206 and 1208, more generally add and/or drop channels may be added and/or dropped through any of the optical nodes 1202, 1204, 1206 and 1208.

Moreover, although the example optical ring networks 1000 and 1200 depicted in FIGS. 15 and 17 each include four optical nodes, more generally optical ring networks according to embodiments of the present invention may include any number of optical nodes.

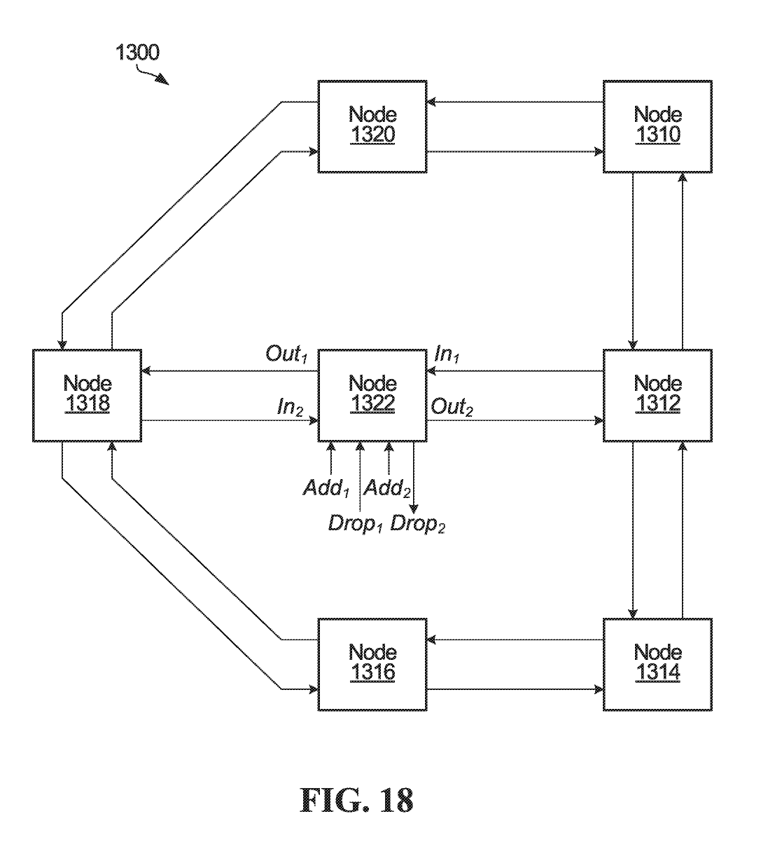

Although FIGS. 15 and 17 depict examples of optical networks based on ring architectures, embodiments of the present invention are not limited to ring architectures. An example of an optical network with a non-ring architecture according to an embodiment of the present invention will now be discussed with reference to FIG. 18, which is a block diagram of an example of another optical network 1300 with multiple optical nodes 1310, 1312, 1314, 1316, 1318, 1320 and 1322 having optical add-drop functionality according to an embodiment of the present invention.

In the optical network 1300, the optical nodes 1310, 1312, 1314, 1316, 1318, 1320 and 1322 are optically interconnected such that the optical nodes optical nodes 1310, 1312, 1314, 1316, 1318 and 1320 are bi-directionally connected in a ring topology, but the optical node 1322 is bi-directionally connected between the optical nodes 1312 and 1318. As such, the optical nodes 1318 and 1312 are three degree nodes, while the optical nodes 1310, 1314, 1316, 1320 and 1322 are two degree nodes.

The optical node 1322 may be implemented with bi-directional ADM functionality as described above in order to allow the optical nodes 1312 and 1318 to communicate directly through channel wavelengths/bands in the pass band of the optical node 1322, while also allowing channels to be locally added and/or dropped in either direction.

It will be appreciated that such functionality may not only be useful in “bridging” an otherwise ring shaped network, as depicted in FIG. 18, but may also be useful in an optical node that links two optical networks that may not otherwise be linked. For example, ADM functionality according to an embodiment of the present invention may be implemented in an optical node that acts as a link between two optical ring networks, thereby allowing optical communication to be passed between the rings, as well as allowing it to be dropped from and/or added to either ring locally at the optical node linking the two rings.

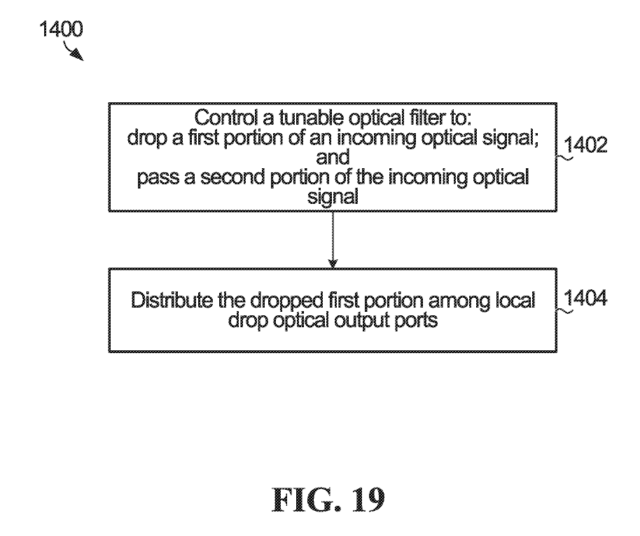

FIG. 19 is a flow diagram of an example method. The example method 1400 relates to drop functionality for optical add-drop multiplexing in all optical networking, and includes controlling a tunable optical filter to drop a first portion of an incoming optical signal in a first wavelength band and pass a second portion of the incoming optical signal in a second wavelength band, at 1402. At 1404, the dropped first portion of the incoming optical signal in the first wavelength band is distributed among multiple of local drop optical output ports.

The example method 1400 is illustrative of one embodiment. In other embodiments, similar or different operations could be performed in a similar or different order. Various ways to perform the illustrated operations, as well as examples of other operations that may be performed, are described herein. Further variations may be or become apparent.

For example, in some embodiments, controlling the tunable optical filter at 1402 involves configuring the tunable optical filter to lower an optical loss in the passed second portion of the incoming optical signal in the second wavelength band at the account of a corresponding increase of an optical loss in the dropped first portion of the incoming optical signal in the first wavelength band.

In some cases, controlling the tunable optical filter at 1402 involves wavelength-tuning the tunable optical filter to adjust a center wavelength of the first wavelength band, bandwidth-tuning the tunable optical filter to adjust bandwidth of the first wavelength band, or both.

In order to provide add functionality, the method 1400 may further include combining local add optical input signals in a third wavelength band into an add optical input signal and controlling the tunable optical filter to add the add optical input signal to the passed second portion of the incoming optical signal in the second wavelength band.

In some implementations, the tunable optical filter may be implemented with two three-port tunable optical filters. In such implementations, controlling the tunable optical filter at 1402 may include controlling a first three-port tunable optical filter to drop the first portion of the incoming optical signal in the first wavelength band and pass the second portion of the incoming optical signal in the second wavelength band, and controlling a second three-port tunable optical filter to add the add optical input signal in the third wavelength band to the passed second portion of the incoming optical signal in the second wavelength band. In some such cases, controlling the first three-port tunable optical filter involves configuring the first three-port tunable optical filter to lower an optical loss in the passed second portion of the incoming optical signal in the second wavelength band at the account of a corresponding increase of an optical loss in the dropped first portion of the incoming optical signal in the first wavelength band. Similarly, controlling the second three-port tunable optical filter may involve configuring the second three-port tunable optical filter to lower an optical loss in the passed second portion of the incoming optical signal in the second wavelength band at the account of a corresponding increase of an optical loss in the add optical input signal in the third wavelength band.

In some implementations, distributing the dropped first portion of the incoming optical signal in the first wavelength band among local drop optical output ports at 1404 involves controlling multiple of tunable optical filters arranged in a cascade. For example, each tunable optical filter in the cascade may be operable to drop a respective portion of the dropped first portion of the incoming optical signal to a respective local drop optical output port. In some such embodiments, controlling the multiple tunable optical filters arranged in the cascade involves wavelength-tuning one or more of the tunable optical filters to each drop a respective channel wavelength in the first wavelength band.

Similarly, in those embodiments in which the method 1400 further includes combining local add optical input signals in the third wavelength band into the add optical input signal, such combining may involve controlling multiple tunable optical filters arranged in a cascade. For example, each tunable optical filter in the cascade may be tunable to add a respective local add optical input signal from a respective local add optical input port into the add optical input signal. In some such embodiments, controlling the multiple tunable optical filters arranged in the cascade involves wavelength-tuning one or more of the tunable optical filters to each add a respective channel wavelength in the third wavelength band.

Methods as disclosed herein could be performed or implemented at an optical network node for all optical networking.

Numerous modifications and variations of the present application are possible in light of the above teachings. It is therefore to be understood that within the scope of the appended claims, the application may be practised otherwise than as specifically described herein.

In addition, although described primarily in the context of methods, apparatus and equipment, other implementations are also contemplated, such as in the form of instructions stored on a non-transitory computer-readable medium, for example.

We claim:

1. An apparatus for all optical networking (AON) comprising:
a tunable optical filter having an incoming optical input port to receive an incoming optical signal, a drop optical output port and an outgoing optical output port, the tunable optical filter being controllable to:
drop a first portion of the incoming optical signal in a first wavelength band to the drop optical output port; and
pass a second portion of the incoming optical signal in a second wavelength band to the outgoing optical output port; and
a demultiplexer, optically connected to the drop optical output port of the tunable optical filter, to distribute the dropped first portion of the incoming optical signal in the first wavelength band among a plurality of local drop optical output ports.

2. The apparatus of claim 1, wherein the tunable optical filter is configured to lower an optical loss between the incoming optical input port and the outgoing optical output port in the second wavelength band at the account of a corresponding increase of an optical loss between the incoming optical input port and the drop optical output port in the first wavelength band.

3. The apparatus of claim 1, wherein the tunable optical filter is one or more of wavelength-tunable to adjust a center wavelength of the first wavelength band and bandwidth-tunable to adjust bandwidth of the first wavelength band.

4. The apparatus of claim 1, wherein the tunable optical filter comprises a tunable Mach-Zehnder Interferometer and Resonator Ring (MZI/RR) hybrid optical filter comprising:
a Mach-Zehnder Interferometer (MZI) structure comprising:
a first optical coupler having an optical input port optically connected to the incoming optical input port, a first optical output port, and a second optical output port;
a second optical coupler having a first optical input port, a second optical input port, a first optical output port optically connected to the outgoing optical output port, and a second optical output port optically connected to the drop optical output port;
a first optical path optically connecting the first optical output port of the first optical coupler to the first optical input port of the second optical coupler; and
a second optical path optically connecting the second optical output port of the first optical coupler to the second optical input port of the second optical coupler; and
a tunable Resonator Ring (RR) filter, optically coupled to the first optical path, tunable to filter an optical signal propagating through the first optical path to:
drop the first portion of the incoming optical signal in the first wavelength band to the drop optical output port; and
pass the second portion of the incoming optical signal in the second wavelength band to the outgoing optical output port.

5. The apparatus of claim 4, wherein the tunable RR filter comprises:
a resonator ring; and
a variable optical coupler to optically couple the resonator ring to the first optical path, wherein the variable optical coupler is controllable to adjust the bandwidth of the tunable RR filter by adjusting the optical coupling between the resonator ring and the first optical path.

6. The apparatus of claim 5, wherein the variable optical coupler of the tunable RR filter comprises:
a MZI structure comprising:
a third optical coupler having a first optical input port optically connected to one end of an optical waveguide of the resonator ring, a second optical input port optically connected to the first optical output port of the first optical coupler, a first optical output port, and a second optical output port;
a fourth optical coupler having a first optical input port, a second optical input port, a first optical output port optically connected to an opposite end of the optical waveguide of the resonator ring, and a second optical output port optically connected to the first optical input port of the second optical coupler;
a third optical path optically connecting the first optical output port of the third optical coupler to the first optical input port of the fourth optical coupler; and
a fourth optical path optically connecting the second optical output port of the third optical coupler to the second optical input port of the fourth optical coupler, the fourth optical path comprising a controllable optical phase shifter to adjust the optical coupling between the resonator ring and the first optical path by adjusting a relative optical phase shift between the third optical path and the fourth optical path.

7. The apparatus of claim 1, wherein the tunable optical filter further comprises an add optical input port, and is configured to add an add optical input signal in a third wavelength band from the add optical input port to the outgoing optical output port, and the apparatus further comprises a multiplexer, optically connected to the add optical input port, to combine local add optical input signals in the third wavelength band from a plurality of local add optical input ports into the add optical input signal.

8. The apparatus of claim 7, wherein the tunable optical filter comprises a tunable Mach-Zehnder Interferometer and Resonator Ring (MZI/RR) hybrid optical filter comprising:
a Mach-Zehnder Interferometer (MZI) structure comprising:
a first optical coupler having an optical input port optically connected to the incoming optical input port, a first optical output port, and a second optical output port;
a second optical coupler having a first optical input port, a second optical input port, and an optical output port optically connected to the outgoing optical output port;
a first optical path optically connecting the first optical output port of the first optical coupler to the first optical input port of the second optical coupler; and
a second optical path optically connecting the second optical output port of the first optical coupler to the second optical input port of the second optical coupler; and
a tunable Resonator Ring (RR) filter, optically coupled to the first optical path, tunable to filter an optical signal propagating through the first optical path to:
add the add optical input signal in the third wavelength band from the add optical input port to the outgoing optical output port; and
pass the second portion of the incoming optical signal in the second wavelength band to the outgoing optical output port.

9. The apparatus of claim 8, wherein the optical input port of the first optical coupler is a first optical input port, and the first optical coupler has a second optical input port that is optically connected to the add optical input port to receive the add optical input signal.

10. The apparatus of claim 8, wherein the second tunable RR filter comprises a first side and a second side, the first side being optically coupled to the first optical path and the second side being optically coupled to the add optical input port to receive the add optical input signal, the tunable RR filter being configured to optically couple the add optical input signal from the add optical input port to the first optical path.

11. The apparatus of claim 8, wherein the tunable RR filter optically coupled to the first optical path is a first tunable RR filter and the MZI/RR hybrid optical filter further comprises a second tunable RR filter, optically coupled to the second optical path, tunable to filter an optical signal propagating through the second optical path to:
drop the first portion of the incoming optical signal in the first wavelength band to the drop optical output port; and
pass the second portion of the incoming optical signal in the second wavelength band to the outgoing optical output port.

12. The apparatus of claim 11, wherein the optical output port of the second optical coupler is a first optical output port, and the second optical coupler has a second optical output port that is optically connected to the drop optical output port to transmit a drop optical output signal comprising the first portion of the incoming optical signal in the first wavelength band.

13. The apparatus of claim 11, wherein the second tunable RR filter comprises a first side and a second side, the first side being optically coupled to the second optical path and the second side being optically coupled to the drop optical output port, the second tunable RR filter being configured to optically couple a drop optical output signal comprising the first portion of the incoming optical signal in the first wavelength band from the second optical path to the drop optical output port.

14. The apparatus of claim 8, wherein the first and second optical couplers are variable optical couplers controllable to provide a power adjustment capability between the optical input port of the first optical coupler and the optical output port of the second optical coupler.

15. The apparatus of claim 7, wherein the tunable optical filter comprises:
a first three-port tunable optical filter comprising the incoming optical input port, the drop optical output port, and a pass optical output port, the first three-port tunable optical filter being controllable to:
drop the first portion of the incoming optical signal in the first wavelength band to the drop optical output port; and
pass the second portion of the incoming optical signal in the second wavelength band to the pass optical output port; and
a second three-port tunable optical filter that includes the add optical input port, the outgoing optical output port, and a pass optical input port optically connected to the pass optical output port of the first three-port tunable optical filter, the second three-port tunable optical filter being controllable to:
add an add optical input signal in the third wavelength band from the add optical input port to the outgoing optical output port; and
pass the second portion of the incoming optical signal in the second wavelength band from the pass optical input port to the outgoing optical output port.

16. The apparatus of claim 15, wherein:
the first tunable optical filter is configured to lower an optical loss between the incoming optical input port and the pass optical output port in the second wavelength band at the account of a corresponding increase of an optical loss between the incoming optical input port and the drop optical output port in the first wavelength band; and
the second tunable optical filter is configured to lower an optical loss between the pass optical input port and the outgoing optical output port in the second wavelength band at the account of a corresponding increase of an optical loss between the add optical input port and the outgoing optical output port in the third wavelength band.

17. The apparatus of claim 15, wherein the second three-port tunable optical filter further comprises a three-port tunable Mach-Zehnder Interferometer and Resonator Ring (MZI/RR) hybrid optical filter comprising:
a Mach-Zehnder Interferometer (MZI) structure comprising:
a first optical coupler having a first optical input port optically connected to the pass optical input port, a second optical input port optically connected to the add optical input port, a first optical output port, and a second optical output port;
a second optical coupler having a first optical input port, a second optical input port, and an optical output port optically connected to the outgoing optical output port;
a first optical path optically connecting the first optical output port of the first optical coupler to the first optical input port of the second optical coupler; and
a second optical path optically connecting the second optical output port of the first optical coupler to the second optical input port of the second optical coupler; and
a tunable Resonator Ring (RR) filter, optically coupled to the first optical path, tunable to filter an optical signal propagating through the first optical path to:
add the add optical input signal in the third wavelength band from the add optical input port to the outgoing optical output port; and
pass the second portion of the incoming optical signal in the second wavelength band from the pass optical input port to the outgoing optical output port.

18. The apparatus of claim 1, wherein the demultiplexer comprises a plurality of 1×2 optical splitters arranged to distribute the dropped first portion of the incoming optical signal in the first wavelength band among the plurality of local drop optical output ports.

19. The apparatus of claim 1, wherein the demultiplexer comprises a plurality of 1×2 optical switches configured as variable splitters controllable to selectively distribute the dropped first portion of the incoming optical signal in the first wavelength band among the plurality of local drop optical output ports.

20. The apparatus of claim 1, wherein the tunable optical filter is a main tunable optical filter, and the demultiplexer comprises a plurality of tunable optical filters arranged in a cascade, with a first tunable optical filter in the cascade optically connected to the drop optical output port of the main tunable optical filter to receive the dropped first portion of the incoming optical signal in the first wavelength band, each tunable optical filter in the cascade being tunable to drop a respective portion of the dropped first portion of the incoming optical signal to a respective local drop optical output port of the plurality of local drop optical output ports.

21. The apparatus of claim 20, wherein each tunable optical filter in the cascade is wavelength-tunable to drop a respective channel wavelength in the first wavelength band.

22. The apparatus of claim 7, wherein the tunable optical filter is a main tunable optical filter, and the multiplexer comprises a plurality of tunable optical filters arranged in a cascade, with a last tunable optical filter in the cascade optically connected to the add optical input port of the main tunable optical filter to transmit the add optical input signal in the third wavelength band, each tunable optical filter in the cascade being tunable to add a respective local add optical input signal from a respective local add optical input port of the plurality of local add optical input ports into the add optical input signal for the main tunable optical filter.

23. The apparatus of claim 22, wherein each tunable optical filter in the cascade is wavelength-tunable to add a respective channel wavelength in the third wavelength band.

24. A method for all optical networking (AON) comprising:
controlling a tunable optical filter to:
drop a first portion of an incoming optical signal in a first wavelength band; and
pass a second portion of the incoming optical signal in a second wavelength band; and
distributing the dropped first portion of the incoming optical signal in the first wavelength band among a plurality of local drop optical output ports.

25. The method of claim 24, wherein controlling the tunable optical filter comprises configuring the tunable optical filter to lower an optical loss in the passed second portion of the incoming optical signal in the second wavelength band at the account of a corresponding increase of an optical loss in the dropped first portion of the incoming optical signal in the first wavelength band.

26. The method of claim 24, wherein controlling the tunable optical filter comprises one or more of:
wavelength-tuning the tunable optical filter to adjust a center wavelength of the first wavelength band; and
bandwidth-tuning the tunable optical filter to adjust bandwidth of the first wavelength band.

27. The method of claim 24, further comprising:
combining local add optical input signals in a third wavelength band into an add optical input signal in the third wavelength band; and
controlling the tunable optical filter to add the add optical input signal in the third wavelength band to the passed second portion of the incoming optical signal in the second wavelength band.

28. The method of claim 27, wherein controlling the tunable optical filter comprises:
controlling a first three-port tunable optical filter to:
drop the first portion of the incoming optical signal in the first wavelength band; and
pass the second portion of the incoming optical signal in the second wavelength band; and
controlling a second three-port tunable optical filter to:
add the add optical input signal in the third wavelength band to the passed second portion of the incoming optical signal in the second wavelength band.

29. The method of claim 28, wherein:
controlling the first three-port tunable optical filter comprises configuring the first three-port tunable optical filter to lower an optical loss in the passed second portion of the incoming optical signal in the second wavelength band at the account of a corresponding increase of an optical loss in the dropped first portion of the incoming optical signal in the first wavelength band; and
controlling the second three-port tunable optical filter comprises configuring the second three-port tunable optical filter to lower an optical loss in the passed second portion of the incoming optical signal in the second wavelength band at the account of a corresponding increase of an optical loss in the add optical input signal in the third wavelength band.

30. The method of claim 24, wherein distributing the dropped first portion of the incoming optical signal in the first wavelength band among a plurality of local drop optical output ports comprises controlling a plurality of tunable optical filters arranged in a cascade, each tunable optical filter in the cascade being operable to drop a respective portion of the dropped first portion of the incoming optical signal to a respective local drop optical output port of the plurality of local drop optical output ports.

31. The method of claim 30, wherein controlling the plurality of tunable optical filters arranged in the cascade comprises wavelength-tuning a tunable optical filter in the cascade to drop a respective channel wavelength in the first wavelength band.

32. The method of claim 27, wherein combining local add optical input signals in the third wavelength band into the add optical input signal in the third wavelength band comprises controlling a plurality of tunable optical filters arranged in a cascade, each tunable optical filter in the cascade being tunable to add a respective local add optical input signal from a respective local add optical input port of the plurality of local add optical input ports into the add optical input signal.

33. The method of claim 32, wherein controlling the plurality of tunable optical filters arranged in the cascade comprises wavelength-tuning a tunable optical filter in the cascade to add a respective channel wavelength in the third wavelength band.
